(19) United States
(12) Patent Application Publication
(10) Pub. No.: US 2025/0055505 A1
(43) Pub. Date: Feb. 13, 2025

(54) SYSTEMS AND METHODS UTILIZING DOPPLER FREQUENCY VALUES FOR WIRELESS COMMUNICATION

(71) Applicant: QUALCOMM Incorporated, San Diego, CA (US)

(72) Inventors: Min Huang, Beijing (CN); Jing Dai, Beijing (CN); Chenxi Hao, Beijing (CN); Liangming Wu, Beijing (CN); Wei Xi, Beijing (CN); Chao Wei, Beijing (CN); Hao Xu, Beijing (CN)

(21) Appl. No.: 18/717,700

(22) PCT Filed: Feb. 17, 2022
(86) PCT No.: PCT/CN2022/076579

§ 371 Date: Jun. 7, 2024

(51) Int. Cl. H04B 7/0408; H04B 7/0456; H04B 7/06; H04B 7/08; H04L 5/00

(52) U.S. Cl. CPC H04B 7/0408; H04B 7/0456; H04B 7/0663; H04B 7/06952; H04B 7/088; H04L 5/0048

(57) ABSTRACT

Aspects of the disclosure relate to a method of, and apparatus for, wireless communication by a user equipment (UE). The method includes receiving a set of reference signals and transmitting, based at least in part on the set of reference signals: a set of Doppler frequency values and a set of weight values that correspond to the set of Doppler frequency values. In another example, a method of, and apparatus for, wireless communication by a base station (BS) is disclosed. The method includes transmitting, to the UE, a signal that has been precoded based at least in part on the set of Doppler frequency values, and the corresponding set of weight values. Other aspects, embodiments, and features are also claimed and described.

### TECHNICAL FIELD

The technology discussed below relates generally to wireless communication systems, and more particularly, to channel estimation corresponding to an aging wireless channel.

### INTRODUCTION

Modern wireless communication systems frequently employ multi-antenna technology for a variety of reasons. Some examples of multi-antenna technology include beamforming, transmit diversity, and spatial multiplexing. One particular example of spatial multiplexing is a multi-input multi-output (MIMO) system, where a multi-antenna transmitter sends a signal to a multi-antenna receiver (or, in some examples, to multiple single-antenna receivers). By utilizing MIMO, a wireless communication system can exploit the spatial domain to multiply the throughput on a given channel. That is, when the different spatial signature of transmissions, from different spatially-located antennas, is combined with an analysis of the multipath nature of a channel, multiple different streams of data can be transmitted simultaneously on the same time-frequency resource. However, such a MIMO system relies on an accurate channel estimate to characterize a multipath channel. In many systems, a channel estimate can be generated by way of the measurement of a suitable reference signal over the channel. While channel estimation can be done with such a reference signal, the efficacy of the estimate may be hindered by various factors (e.g., fading, channel aging, etc.).

One technique for addressing channel aging, for example, is to generate a channel estimate more frequently. This approach, however, results in increased overhead for reference signal transmissions and channel state information (CSI) feedback, and may decrease throughput. Another approach for addressing channel aging is to employ channel prediction, attempting to anticipate the channel aging. However, the effectiveness of previously existing channel prediction algorithms has been less than optimal. For example, existing designs include channel prediction by using a finite impulse response (FIR) Wiener predictor. However, this filter is an ideal filter, which cannot be practically implemented. Another approach includes the use of a Kalman filter for channel prediction. While practical, this approach may still result in less than ideal channel predictions. Therefore, there is room in the field for an approach to channel estimation that can address channel aging in a practical manner, and without relying on the above-described unrealistic assumptions.

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

In one example, a method for wireless communication by a user equipment (UE) is disclosed. The method includes receiving a set of reference signals (e.g., a set of channel state information reference signals (CSI-RSs)). The method further includes transmitting, based at least in part on the set of reference signals: a set of Doppler frequency values, and a set of weight values that correspond to the set of Doppler frequency values. Utilizing the set of Doppler frequency values (e.g., Doppler frequency values weighted via the corresponding set of weight values) for wireless communication enables the device that is receiving the set of Doppler frequency values and corresponding weight values to accurately account for the otherwise anomalous effects of channel aging that occur when a UE is moving at relatively high speeds known to present an increase in Doppler effect challenges with respect to the exchange of signals between the fast-moving UE and the receiving device (e.g., a base station (BS)). The receiving device can be configured to account for the effects of channel aging by utilizing the set of Doppler frequency values and corresponding weight values when the receiving device subsequently transmits data or other signals to the fast-moving UE. The receiving device can be configured to transmit such signals to the UE for a predetermined amount of time prior to receiving, from the UE, a subsequent set of Doppler frequency values and corresponding weight values that the UE may transmit, to the receiving device, at a subsequent point in time.

In another example, an apparatus for wireless communication by a UE is disclosed. The apparatus includes: a processor, a transceiver communicatively coupled to the processor; and a memory communicatively coupled to the processor. In such examples, the apparatus may be configured to receive, from a base station (BS) via the transceiver, a set of reference signals (e.g., a set of channel state information reference signals (CSI-RSs)). Additionally, the apparatus can be configured to transmit, to the BS via the transceiver, a set of Doppler frequency values, and a set of weight values that correspond to the set of Doppler frequency values (for the BS to utilize when updating its downlink (DL) precoding matrix).

In another example, a non-transitory computer-readable storage medium having stored thereon instructions that, when executed, cause one or more processors of a UE to perform a method for wireless communication is disclosed. In an example, the instructions, when executed, may be configured to cause the one or more processors to receive, from a base station (BS) via a transceiver, a set of reference signals (e.g., a set of channel state information reference signals (CSI-RSs)). Additionally, the instructions, when executed, may be configured to cause the one or more processors to transmit, to the BS via the transceiver, a set of Doppler frequency values, and a set of weight values that correspond to the set of Doppler frequency values (for utilization in updating, by the BS, a downlink (DL) precoding matrix).

In another example, a system for wireless communication by a UE is disclosed. The system includes: at least one processor, and at least one transceiver communicatively coupled to the at least one processor. In such examples, the system may be configured for communicating, via the at least one transceiver, a set of reference signals (e.g., a set of channel state information reference signals (CSI-RSs)). Additionally, the system is configured for, in return, communicating, via the at least one transceiver, a set of Doppler frequency values, and a corresponding set of weight values.

In another example, an apparatus for wireless communication by a UE is disclosed. The apparatus includes means for receiving a set of reference signals (e.g., a set of channel state information reference signals (CSI-RSs)). The apparatus further includes means for transmitting, based at least in part on the set of reference signals: (i) a set of Doppler frequency values, and (ii) a set of weight values that correspond to the set of Doppler frequency values. In some examples, the means for transmitting the Doppler frequency values and corresponding set of weight values include means for determining, from the set of reference signals, the set of Doppler frequency values, and means for determining, based at least in part on the set of Doppler frequency values, the corresponding set of weight values.

In some examples, a method of wireless communication by a scheduling entity (e.g., a base station (BS)) is disclosed. The method includes: receiving, via a communication network, a set of Doppler frequency values; receiving a set of weight values corresponding to the set of Doppler frequency values; and transmitting, via the communication network, a downlink (DL) signal precoded based at least in part on: (i) the set of Doppler frequency values, and (ii) the set of weight values corresponding to the set of Doppler frequency values.

In another example, an apparatus for wireless communication by a scheduling entity is disclosed. The apparatus includes: a processor, a transceiver communicatively coupled to the processor; and a memory communicatively coupled to the processor. In such examples, the apparatus may be configured to receive: (i) a set of Doppler frequency values, and (ii) a set of weight values that correspond to the set of Doppler frequency values. The apparatus may be further configured to transmit, to a user equipment (UE) via a communication network, a downlink (DL) signal, where the DL signal is precoded based at least in part on: (i) the set of Doppler frequency values, and (ii) the corresponding set of weight values.

In another example, a non-transitory computer-readable storage medium having stored thereon instructions that, when executed, cause one or more processors of a BS to perform a method for wireless communication is disclosed. In an example, the instructions, when executed, may be configured to cause the one or more processors to transmit a channel state information (CSI) report configuration message to a UE. The CSI report configuration message may be configured to cause the UE to transmit, to the BS: (i) a set of Doppler frequency values, and (ii) a set of weight values corresponding to the set of Doppler frequency values. In such examples, the instructions, when executed, may be configured to cause the one or more processors to receive the set of Doppler frequency values, and the set of weight values. Accordingly, the instructions, when executed, may be configured to cause the one or more processors to transmit (e.g., via a transceiver over a wireless communication network) a downlink (DL) signal precoded, the precoded DL signal being precoded based at least in part on: (i) the set of Doppler frequency values, and (ii) the set of weight values.

In another example, a system for wireless communication by a BS is disclosed. The system includes: at least one processor, and at least one transceiver communicatively coupled to the at least one processor. In such examples, the system may be configured for transmitting, via the at least one transceiver, a set of reference signals to a UE. Additionally, the system is configured for receiving, via the at least one transceiver, a set of Doppler frequency values, and a corresponding set of weight values for the BS to utilize when precoding a subsequent DL signal.

In another example, an apparatus for wireless communication by a BS is disclosed. The apparatus includes means for transmitting a set of reference signals to a UE. The apparatus includes means for receiving, in return from the UE: (i) a set of Doppler frequency values, and (ii) a set of weight values that correspond to the set of Doppler frequency values. The apparatus further includes means for transmitting a downlink (DL) signal precoded based at least in part on: (i) the set of Doppler frequency values, and (ii) the set of weight values corresponding to the set of Doppler frequency values. In such examples, the means for transmitting the precoded DL signal includes means for precoding the DL signal based at least in part on the set of Doppler frequency values, and the corresponding set of weight values.

In accordance with one or more of the various techniques of this disclosure, such as those described above, the UE may advantageously transmit, to the BS, the set of Doppler frequency values and corresponding weight values after receiving, from the BS, the set of reference signals, such that the set of Doppler frequency values and corresponding weight values are determined based on the set of reference signals received overtime (e.g., at discrete points in time, over different slots, etc.). In such examples, the UE may transmit, to the BS, an optimal amount of information useful in combating the Doppler effect in certain examples. The UE may simultaneously achieve an advantageously low overhead by transmitting the Doppler frequency values less often than the BS transmits the set of reference signals to the UE.

In some examples, the set of reference signals may correspond to a first beam of a plurality of beams, and the plurality of beams may correspond to a first transmission layer of a plurality of transmission layers. In such examples, the user equipment (UE) may further: transmit, based at least in part on the set of reference signals, a set of delay values that corresponds to the first beam. In yet another example, each Doppler frequency value (or at least some) of the set of Doppler frequency values may be associated with at least one delay value of the set of delay values. In an alternative, or additional, example, each delay value (or at least some) of the set of delay values may be associated with at least one Doppler frequency value of the set of Doppler frequency values. In another example, the transmitting of the set of Doppler frequency values may include applying a size delimiting parameter defining: a first threshold number of Doppler frequency values, or a second threshold number of delay-Doppler value pairs. In yet another example, the UE may quantize the set of Doppler frequency values to produce a quantized set of Doppler frequency values, where the transmitting of the set of Doppler frequency values includes transmitting the quantized set of Doppler frequency values. In another aspect, the UE may quantize the set of weight values to produce a quantized set of weight values, where the transmitting of the set of weight values includes transmitting the quantized set of weight values. In yet another aspect, determining a set of commonality parameters; and applying the set of commonality parameters to the set of Doppler frequency values to produce a condensed set of Doppler frequency values, wherein the transmitting the set of Doppler frequency values comprises transmitting the condensed set of Doppler frequency values.

In another example, the base station (BS) may transmit the downlink (DL) signal (e.g., as a precoded DL signal) by determining a DL precoding matrix based at least in part on the set of Doppler frequency values and the set of weight values; and transmitting, based at least in part on the DL precoding matrix, the DL signal. In some examples, the BS may transmit, to a user equipment (UE), a set of reference signals, where the set of reference signals corresponds to a first beam of a plurality of beams, and where the plurality of beams corresponds to a first transmission layer of a plurality of transmission layers. In another example, the BS may receive, from the UE and based at least in part on the set of reference signals, a set of delay values that corresponds to the first beam. In such examples, each Doppler frequency value of the set of Doppler frequency values may be associated with at least one delay value of the set of delay values. Alternatively, in some examples, each delay value of the set of delay values may be associated with at least one Doppler frequency value of the set of Doppler frequency values. That is, the UE may associate each Doppler frequency value of the set of Doppler frequency values with at least one delay value of the set of delay values, or may associate each delay value of the set of delay values with at least one Doppler frequency value of the set of Doppler frequency values, or may perform a combination thereof, such that the BS may receive the set of Doppler frequency values and the corresponding set of weight values in accordance with such value associations.

In yet another example, the BS may determine a report period defining a threshold number of reference signals for the set of reference signals (e.g., ‘X’ reference signals per report period, where ‘X’ is a positive integer), or a length of time for the receiving of the set of reference signals (e.g., ‘X’ slots, where ‘X’ is a positive integer), where the receiving of the set of Doppler frequency values and the set of weight values includes the BS receiving, according to the report period, the set of Doppler frequency values and the set of weight values. In another example, the BS may transmit, to the UE, a channel state information (CSI) report configuration message, where the CSI report configuration message includes a timing parameter for the UE's transmittal of the set of Doppler frequency values, the set of weight values, or both the set of Doppler frequency values and the set of weight values. In yet another example, the CSI report configuration message may include a size delimiting parameter defining (i) a first threshold number of Doppler frequency values (e.g., ‘X’ Doppler frequency values per Doppler frequency report, where ‘X’ is a positive integer), and/or (ii) a second threshold number of delay-Doppler value pairs (e.g., ‘X’ pairs per Doppler frequency report, where ‘X’ is a positive integer). In another example, the BS may transmit, to the UE, a set of commonality parameters, where receiving the set of Doppler frequency values from the UE includes receiving, in accordance with the set of commonality parameters, a condensed set of Doppler frequency values (e.g., condensed in accordance with the commonality parameter).

In such examples, the UE and BS may communicate and utilize the configuration message to determine an optimal configuration for communicating the Doppler frequency values and corresponding weight values therebetween. That is, the BS may provide any combination of these parameters to the UE in order to instruct the UE on how to determine and report back the Doppler frequency values, where the UE is able to utilize such parameters to advantageously determine a plurality of Doppler frequency values based on a plurality of reference signals. In this way, the UE may provide optimal channel state information via the Doppler frequency values and corresponding weight values for the BS to accurately determine and/or update a downlink (DL) precoding matrix regardless of whether the UE is moving at rates fast enough to cause relatively high Doppler frequency values to ensue. Advantageously, the UE may do so, in accordance with the configuration parameters received from the BS, such that the overhead of the UE may be sustained below a predetermined overhead threshold.

In an example, the BS may adjust the size delimiting parameter(s), the commonality parameter(s), the timing parameter(s) (e.g., the report period), the quantization parameter(s), the pairing parameter(s), and/or other parameters to optimize for accuracy while maintaining the UE's overhead below an overhead threshold so as not to overburden the UE and/or the network by not utilizing the parameters for the configuration in the effective, efficiency-promoting manner as described herein.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a wireless communication system according to some aspects of this disclosure.

FIG. 2 is a conceptual illustration of an example of a radio access network according to some aspects of this disclosure.

FIG. 3 is a block diagram illustrating a wireless communication system supporting beamforming and/or multiple-input multiple-output (MIMO) communication according to some aspects of this disclosure.

FIG. 4 is a schematic illustration of an organization of wireless resources in an air interface utilizing orthogonal frequency divisional multiplexing (OFDM) according to some aspects of this disclosure.

FIG. 5 is a schematic diagram illustrating a composition of an example precoding matrix for a single layer transmission according to some aspects of this disclosure.

FIG. 6 is a schematic diagram illustrating a composition of an example precoding matrix for a single layer transmission according to some aspects of this disclosure.

FIG. 7 is a schematic diagram illustrating a composition of an example precoding matrix for a multiple layer transmission according to some aspects of this disclosure.

FIG. 8 is a chart schematically illustrating an example throughput degradation according to some aspects of this disclosure.

FIG. 9 is a flow chart illustrating an example of a process for communicating and utilizing Doppler frequency values and corresponding weight values according to some aspects of this disclosure.

FIG. 10 is a schematic diagram illustrating a composition of an example precoding matrix for a single layer transmission and multiple time instances according to some aspects of this disclosure.

FIG. 11 is a timing diagram illustrating an example of a process for a UE to transmit Doppler frequency values and corresponding weight values according to some aspects of this disclosure.

FIG. 12 is a schematic diagram illustrating a beam of a layer corresponding to a set of delay-Doppler value pairs according to some aspects of this disclosure.

FIG. 13 is a schematic diagram illustrating a delay value of a beam corresponding to a set of Doppler frequency values according to some aspects of this disclosure.

FIG. 14 is a schematic diagram illustrating a combination of delay-Doppler value pairs, as well as delay values corresponding to Doppler frequency values in unpaired configurations, according to some aspects of this disclosure.

FIG. 15 is a flow chart illustrating an example of a process for determining quantization parameters for quantizing Doppler frequency values and/or corresponding weight values according to some aspects of this disclosure.

FIG. 16 is a flow chart illustrating an example of a process for determining one or more commonality parameters from a channel state information (CSI) report configuration message according to some aspects of this disclosure.

FIG. 17 is a block diagram conceptually illustrating an example of a hardware implementation for a scheduling entity according to some aspects of this disclosure.

FIG. 18 is a block diagram conceptually illustrating an example of a hardware implementation for a scheduled entity according to some aspects of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

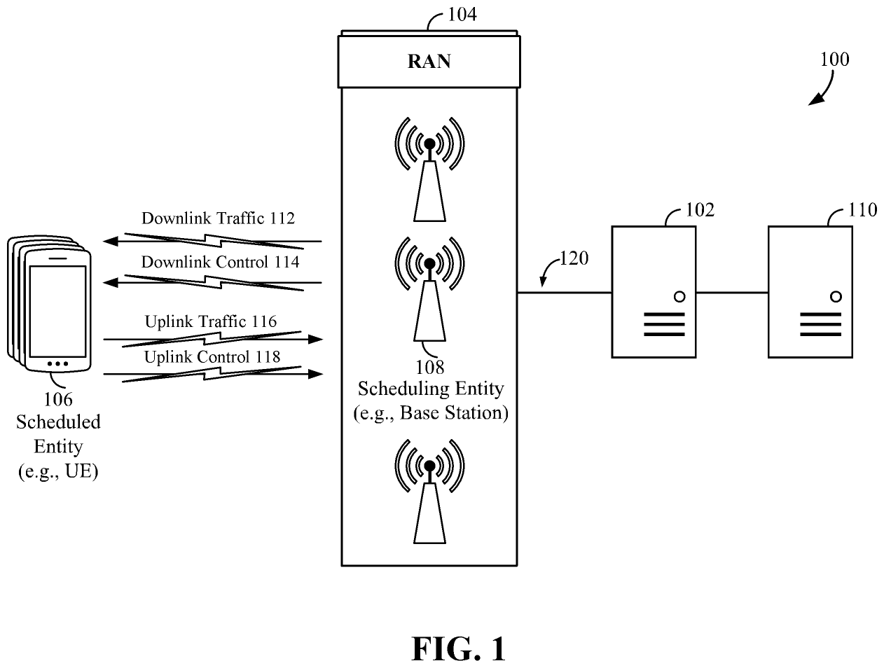

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G or 5G NR. In some examples, the RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a “base station” as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network (RAN) 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 (e.g., a base station (BS)) may broadcast downlink traffic 112 to one or more scheduled entities 106. Broadly, the BS 108 is a node or device responsible for scheduling traffic in a wireless communication network, including the downlink traffic 112 and, in some examples, uplink traffic 116 from one or more scheduled entities 106 to the BS 108. On the other hand, the UE 106 is a node or device that receives downlink control information 114, including but not limited to scheduling information (e.g., a grant), synchronization or timing information, or other control information from another entity in the wireless communication network such as the BS 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100. In some examples, the core network 102 may be independent of the radio access technology used in the RAN 104. The core network 102 may be configured according to 5GC, for example. In another example, the core network 102 may be configured according to a 4G evolved packet core (EPC), or any other suitable standard or configuration.

In accordance with one or more of the various techniques of this disclosure, a UE 106 may be configured to receive a set of channel state information (CSI) reference signals (CSI-RSs) from a base station 108. The UE 106 may measure the CSI-RS(s) and transmit a set of Doppler frequency values to the BS in a channel state information (CSI) report. In addition, the UE 106 may transmit a corresponding set of weight values that the UE 106 determines based at least in part on the set of CSI-RS(s). In some examples, the UE 106 may include the set of Doppler frequency values and the corresponding set of weight values, in a CSI report or in some instances, separately from the CSI report. In such examples, the UE 106 may transmit the set of Doppler frequency values and the corresponding set of weight values in accordance with a CSI report configuration message received from the BS 108.

The CSI report may further include, in various instances, channel quality information (CQI), the number of preferred data streams (e.g., rate control, a rank indicator (RI)), and a precoding matrix indicator (PMI). The BS 108 utilizes the CSI report to determine (e.g., generate, update, etc.) a downlink (DL) precoding matrix for precoding a set of DL MIMO transmissions. The BS 108 utilizes a precoding matrix until such time that the BS 108 receives a subsequent set of Doppler frequency values and/or a subsequent corresponding set of weight values (e.g., a next CSI report). The BS 108 utilizes the subsequent set of Doppler frequency values and/or corresponding set of weight values for determining the DL precoding matrix. The BS 108 may utilize the updated DL precoding matrix to precode a plurality of downlink communications to the UE 106.

Updating the DL precoding matrix based on the Doppler frequency values and the corresponding set of weight values provides improved performance of the DL precoding matrix when the UE 106 is traveling at high speeds. At the same time, the UE 106 may maintain a reduced overhead by transmitting CSI reports less frequently (e.g., one CSI report transmitted for every ten CSI-RSs). This overhead reduction provides an advantageous enhancement for MIMO situations in the context of fast-moving UEs 106 and allows for throughput improvements that tend to result from the reduced UE overhead, as well as the improvement to the DL precoding matrix updating techniques of this disclosure. In addition, the CSI report configuration message may include various timing, quantization, size-delimiting, and/or commonality parameters that provide further benefits to the UE's ability to provide the Doppler frequency values and the corresponding set of weight values in an efficient manner. In this way, the UE 106 may provide a scheduling entity 108 with a set of Doppler frequency values and corresponding weight values while advantageously conserving processing, power, and/or memory resources. Meanwhile, the BS 108 may also converse processing, power, and/or memory resources in accordance with one or more of the various techniques of this disclosure when updating its DL precoding matrix based on such Doppler and weight values with robust accuracy to situations where the UE 106 is traveling at such relatively high speeds.

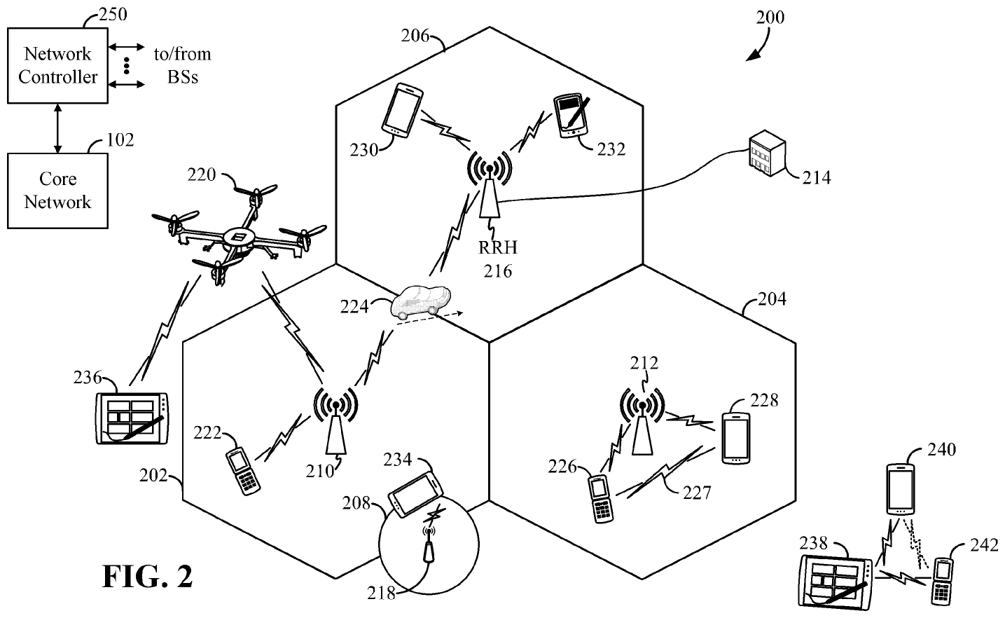

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that a user equipment (UE) can uniquely identify based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

FIG. 2 shows two base stations 210 and 212 in cells 202 and 204; and shows a third base station 214 controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the scheduled entity 106 described above and illustrated in FIG. 1 (e.g., a UE 106). In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In an example, a base station (BS) 108 may transmit, via the RAN 200, a set of reference signals to a UE 106. The UE 106 may receive the set of reference signals from the BS 108. Upon receiving a threshold number of reference signals to satisfy a predefined channel state information (CSI) report period, the UE 106 may transmit a set of Doppler frequency values and a corresponding set of weight values to the BS 108. The BS 108 may define the CSI report period by transmitting a CSI report configuration message to the UE 106 via the RAN 200. The CSI report configuration message may include a set of one or more parameters (e.g., timing parameters, quantization parameters, size-delimiting parameters, commonality parameters, etc.) for configuring the UE 106 to transmit, to the BS 108 via the RAN 200, the set of Doppler frequency values and the corresponding set of weight values in accordance with the set of parameters. In such examples, the timing parameter may define the CSI report period in terms of how many reference signals the UE 106 may receive from the BS 108 over a predetermined time period (e.g., ten reference signals over a duration of ten slots, five reference signals over a duration of ten slots, five reference signals over a duration of five slots, etc.).

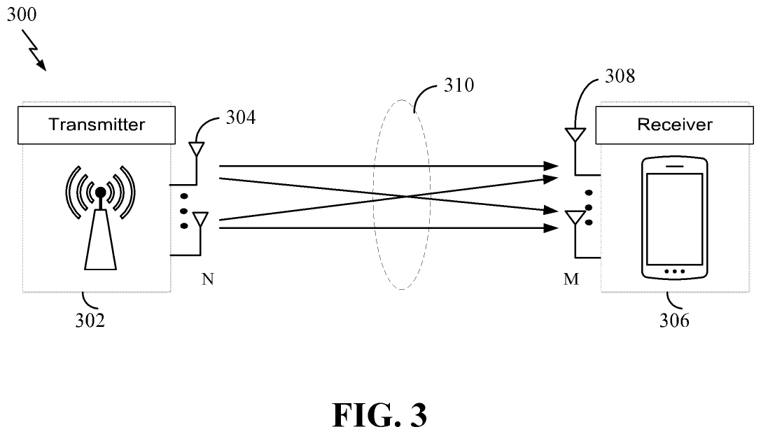

In some aspects of the disclosure, the scheduling entity (e.g., a base station (BS) 108, a UE) and/or scheduled entity (e.g., a UE 106) may be configured with multiple antennas for beamforming and/or multiple-input multiple-output (MIMO) technology. FIG. 3 illustrates an example of a wireless communication system 300 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, a transmitting device may precode, or control the amplitude and phase of each antenna in an array of antennas to create a desired (e.g., directional) pattern of constructive and destructive interference in the wavefront. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a UE 106, or any other suitable wireless communication device.

In a MIMO system, spatial multiplexing may be used to transmit multiple different streams of data, also referred to as layers, simultaneously on the same time-frequency resource. In some examples, a transmitter 302 may send multiple data streams to a single receiver. In this way, a MIMO system takes advantage of capacity gains and/or increased data rates associated with using multiple antennas in rich scattering environments where channel variations can be tracked. Here, the receiver 306 may track these channel variations and provide corresponding feedback to the transmitter 302. In one example case, as shown in FIG. 3, a rank-2 (i.e., including 2 data streams) spatial multiplexing transmission on a 2×2 MIMO antenna configuration will transmit two data streams (e.g., utilizing multiple transmission layers) via two transmit antennas 304. The signal from each transmit antenna 304 reaches each receive antenna 308 along a different signal path 310. The receiver 306 may then reconstruct the data streams using the received signals from each receive antenna 308.

In some examples, a transmitter may send multiple data streams to multiple receivers. This is generally referred to as multi-user MIMO (MU-MIMO). In this way, a MU-MIMO system exploits multipath signal propagation to increase the overall network capacity by increasing throughput and spectral efficiency, and reducing the required transmission energy. This is achieved by a transmitter 302 spatially precoding (i.e., multiplying the data streams with different weighting and phase shifting) each data stream (in some examples, based on known channel state information, Doppler frequency values and corresponding weight values, etc.) and then transmitting each spatially precoded stream through multiple transmit antennas to the receiving devices using the same allocated time-frequency resources. A receiver (e.g., receiver 306) may transmit feedback including a quantized version of the channel so that the transmitter 302 can schedule the receivers with good channel separation. The spatially precoded data streams arrive at the receivers with different spatial signatures, which enables the receiver(s) (in some examples, in combination with known channel state information) to separate these streams from one another and recover the data streams destined for that receiver. In the other direction, multiple transmitters can each transmit a spatially precoded data stream to a single receiver, which enables the receiver to identify the source of each spatially precoded data stream.

In accordance with one or more of the various techniques of this disclosure, the transmitter 302 (e.g., a base station 108) may transmit a set of reference signals (e.g., a set of channel state information reference signals (CSI-RSs)) to the receiver 306 (e.g., a UE 106). The receiver 306 may, in return, communicate a set of Doppler frequency values, and a corresponding set of weight values to the transmitter 302. The transmitter 302 may precode, utilizing a precoding matrix, a set of downlink communications (e.g., each data stream) based on the set of Doppler frequency values, and the corresponding set of weight values and as such, may transmit the precoded DL communications.

The number of data streams or layers in a MIMO or MU-MIMO (generally referred to as MIMO) system corresponds to the rank of the transmission. In general, the rank of a MIMO system is limited by the number of transmit or receive antennas 304 or 308, whichever is lower. In addition, the channel conditions at the receiver 306, as well as other considerations, such as the available resources at the transmitter 302, may also affect the transmission rank. For example, a base station in a RAN (e.g., transmitter 302) may assign a rank for a DL communication to a particular UE (e.g., receiver 306) based on a rank indicator (RI) the UE transmits to the base station. The UE may determine this RI based on the antenna configuration (e.g., the number of transmit and receive antennas) and a measured signal-to-interference-and-noise ratio (SINR) on each of the receive antennas. The RI may indicate, for example, the number of layers that the UE may support under the current channel conditions.

The transmitter 302 determines the precoding of the transmitted data stream or streams based, e.g., on known channel state information of the channel on which the transmitter 302 transmits the data stream(s). For example, the transmitter 302 may transmit one or more suitable reference signals (e.g., a channel state information reference signal, or CSI-RS) that the receiver 306 may measure. The receiver 306 may then report measured channel quality information (CQI) back to the transmitter 302. This CQI generally reports the current communication channel quality, and in some examples, a requested transport block size (TBS) for future transmissions to the receiver. In some examples, the receiver 306 may further report a precoding matrix indicator (PMI) to the transmitter 302. This PMI generally reports the receiver's 306 preferred precoding matrix for the transmitter 302 to use, and may be indexed to a predefined codebook. The transmitter 302 may then utilize this CQI/PMI to determine a suitable precoding matrix for transmissions to the receiver 306.

In some examples, a transmitter 302 may assign a rank for downlink (DL) MIMO transmissions. In such examples, the transmitter 302 may transmit a channel state information reference signal (CSI-RS) to the receiver 306. In an example, the transmitter 302 may transmit a CSI-RS with separate sequences for each layer to provide for multi-layer channel estimation. From the CSI-RS, the receiver 306 may measure the channel quality across layers and resource blocks. The receiver 306 may then transmit a CSI report (including, e.g., CQI, RI, and PMI) to the transmitter 302 for use in updating the DL precoding matrix for precoding subsequent DL communications (e.g., subsequent DL transmissions).

In some examples, the receiver 306 may transmit a set of Doppler frequency values and corresponding weight values to the transmitter 302. In an example, the receiver 306 may receive a set of reference signals from the transmitter 302. In an example, the transmitter 302 may utilize a downlink (DL) precoding matrix precode the set of reference signals to transmit a precoded set of reference signals. In such examples, the receiver 306 can be configured to measure the set of reference signals received from the transmitter 302. The receiver 306 may determine, from the set of reference signals, a set of Doppler frequency values and a corresponding set of weight values to transmit to the transmitter 302. While described throughout this disclosure as being included in a CSI report (e.g., as PMI), the techniques of this disclosure are not so limited. A person of ordinary skill in the art will understand that the receiver 306 may, in some instances, separately transmit the set of Doppler frequency values and/or transmit the corresponding set of weight values.

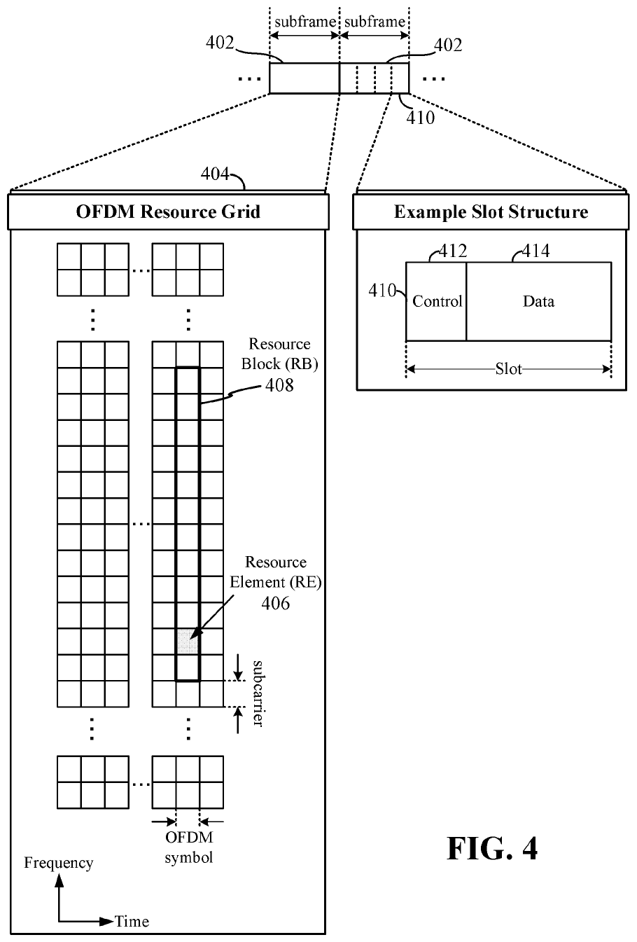

FIG. 4 schematically illustrates various aspects of the present disclosure with reference to an OFDM waveform. Those of ordinary skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may consist of a set of subframes (e.g., 10 subframes of 1 ms each). A given carrier may include one set of frames in the UL, and another set of frames in the DL. FIG. 4 illustrates an expanded view of an exemplary DL subframe 402, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and may contain a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. The present disclosure assumes, by way of example, that a single RB such as the RB 408 entirely corresponds to a single direction of communication (either transmission or reception for a given device).

Although not illustrated in FIG. 4, the various REs 406 within an RB 408 may carry one or more physical channels, including control channels, shared channels, data channels, etc. Other REs 406 within the RB 408 may also carry reference signals (e.g., pilots). As such, a set of reference signals may provide for a receiving device to estimate (e.g., measure) the corresponding channel. In some examples, the resulting channel estimate may enable coherent demodulation/detection of the control and/or data channels within the RB 408.

In a downlink (DL) communication, the transmitting device (e.g., the BS 108) may allocate one or more REs 406 (e.g., within a control region 412) to carry one or more DL control channels. These DL control channels include DL control information 114 (DCI) that generally carries information originating from higher layers, such as a physical broadcast channel (PBCH), a physical downlink control channel (PDCCH), etc., to one or more scheduled entities 106. In addition, the transmitting device may allocate one or more DL REs to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

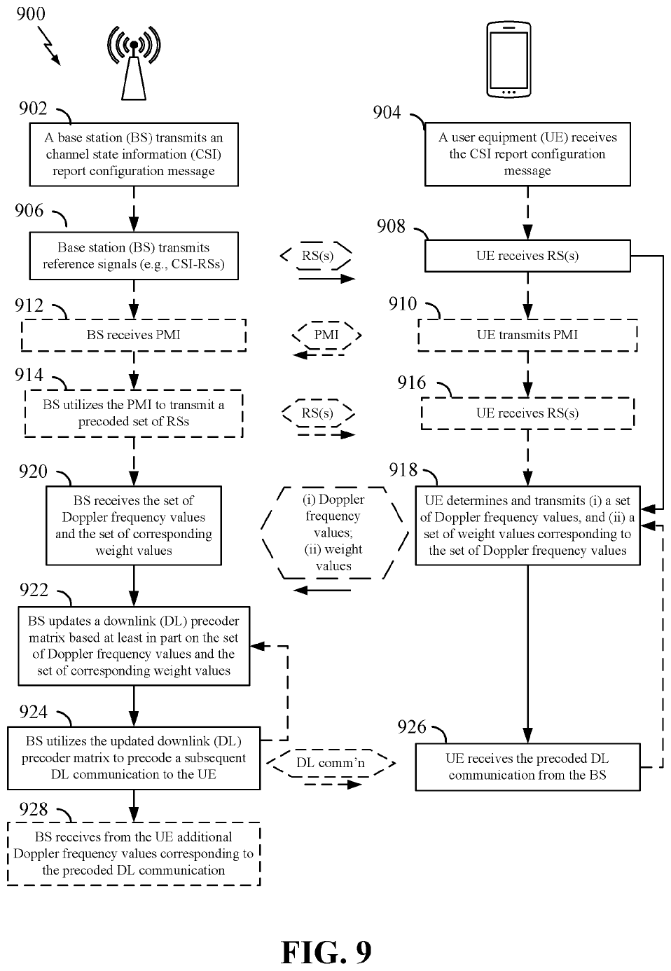

Aspects of the present disclosure provide techniques and apparatus for updating a precoding matrix utilizing a set of Doppler frequency values and a corresponding set of weight values. In an example, a base station (BS) 108 (e.g., a BS, such as a gNB) may transmit, via a set of REs 406, the reference signals to the UE 106. The UE 106 may, in return, transmit to the BS 108 the set of Doppler frequency values and the corresponding set of weight values. As described within this disclosure (e.g., with reference to FIG. 9), the UE 106 may determine, from the set of reference signals, the set of Doppler frequency values and the set of weight values corresponding to the set of Doppler frequency values. The BS 108 may determine and/or update a downlink (DL) precoding matrix over time based on the set of Doppler frequency values and the corresponding set of weight values received from a UE 106.

The DL precoding matrix may be updated over a subsequent CSI report period to transmit various precoded signals to the UE 106. That is, a BS 108 may utilize a single channel state report, in instances where the channel state report includes the set of Doppler frequency values, for example, received at a first time instance to precode a signal transmission for each slot 410 of the subsequent CSI report period. In an illustrative and non-limiting example, the CSI report period may include a report period of one CSI report transmission for every ten slots, where at least one CSI-RS is transmitted with each slot 410.

A base station (BS) 108 may transmit the synchronization signals PSS and SSS (collectively referred to as SS), and in some examples, the PBCH, in an SS block that includes 4 consecutive OFDM symbols, numbered via a time index in increasing order from 0 to 3. In the frequency domain, the SS block may extend over 240 contiguous subcarriers. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs 106 in a cell. This can include, but is not limited to, power control commands, scheduling information, a grant, and/or an assignment of REs for DL and UL transmissions.

In an uplink (UL) communication, a transmitting device (e.g., a UE 106) may utilize one or more REs 406 to carry one or more UL control channels, such as a physical uplink control channel (PUCCH), a physical random access channel (PRACH), etc. These UL control channels include UL control information (UCI) 118 that generally carries information originating from higher layers. Further, UL REs may carry UL physical signals that generally do not carry information originating from higher layers, such as demodulation reference signals (DM-RS), phase-tracking reference signals (PT-RS), sounding reference signals (SRS), etc. In some examples, the UCI 118 may include a scheduling request (SR). In response to the SR transmitted on the UL control channel 118 (e.g., a PUCCH), the BS 108 may transmit downlink control information (DCI) 114 that may schedule resources for UL communications.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy. If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, one or more REs 406 (e.g., within the data region 414) may be allocated for user data or traffic data. Such traffic may be carried on one or more traffic channels, such as, for a DL communication, a physical downlink shared channel (PDSCH); or for an UL communication, a physical uplink shared channel (PUSCH).

The channels or carriers described above and illustrated in FIGS. 1 and 4 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

In some examples, a UE 106 using sidelink (SL) may transmit a channel state information reference signal (CSI-RS) for CSI measurement and reporting in the SL. While some of the various techniques of this disclosure are discussed in terms of a base station precoding downlink (DL) communications for a UE 106, the techniques of this disclosure are not so limited. In some examples, a first UE 106 may receive a set of reference signals from a second UE 106. Accordingly, the first UE 106 may transmit a set of Doppler frequency values and a corresponding set of weight values to the second UE 106. In some examples, the first UE 106 may utilize a suitable feedback or control message, for example, in a medium access control-control element (MAC-CE). The second UE 106 may utilize the Doppler frequency values and the weight values, for example, when updating an SL precoding matrix or to relay the frequency and corresponding weight values to another entity (e.g., a scheduling entity 108).

### Precoding Matrix Composition

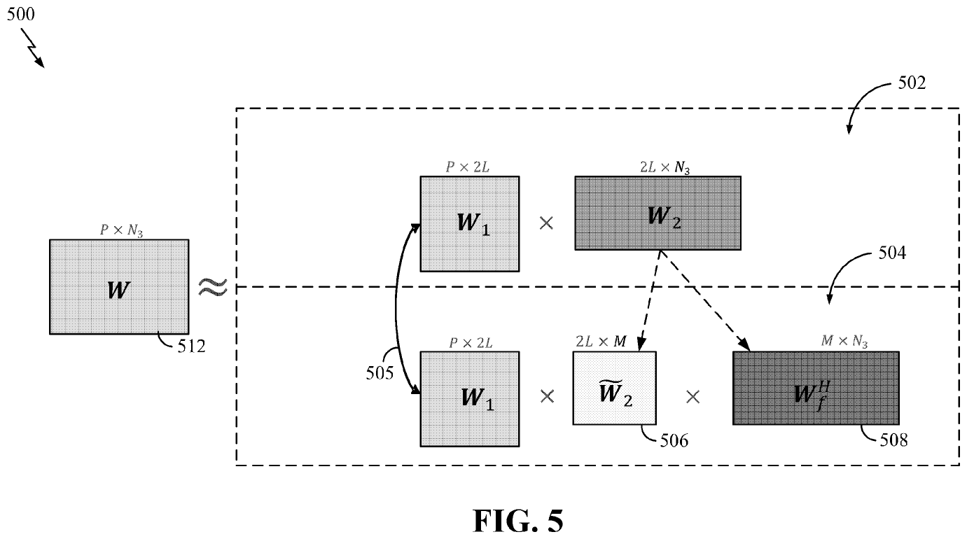

FIG. 5 is a schematic diagram illustrating a composition of an example precoding matrix 500 for a single layer transmission according to some aspects of this disclosure. In some examples, a base station (BS) 108 may implement the example precoding matrix 500 to precode a downlink (DL) communication utilizing multiple subbands, for example, in the single layer transmission. The upper area 502 illustrates the precoding matrix without frequency compression. The lower area 504 illustrates the precoding matrix 512 with frequency compression.

For one layer, an example precoding matrix W 512 with frequency compression may be represented as follows:

W=W₁\tilde{W}₂W_{f}^{H}

In some examples, the precoding matrix W 512 may include: P=2N₁N₂ rows (corresponding to a number of ports in the spatial domain (SD), where N₁ generally represents the number of columns in an antenna panel, and N₂ generally represents the number of rows in the antenna panel), and N₃ columns (frequency-domain compression unit, consisting of resource blocks (RBs) or reporting subbands). The W₁ matrix 505 generally represents the spatial basis consisting of L beams (i.e. L columns) per polarization group, for example, yielding 2L beams. In an example, the W₁ matrix 505 represents an SD compression matrix of the precoding matrix W 512.

The \tilde{W}₂ matrix 506 corresponds to the linear combination coefficients (e.g., amplitude and co-phasing) component of the precoding matrix W 512. In an example, each element (e.g., entry) of the \tilde{W}₂ matrix 506 represents the coefficient of a tap (e.g., the tap coefficient) for a particular beam. Accordingly, a tap coefficient may, in some examples, correspond to a delay value (e.g., a non-zero position of the \tilde{W}₂ matrix 506).

The W_{f}^{H} matrix 508 generally represents a frequency domain (FD) compression matrix of the DL precoding matrix W 512. The W_{f}^{H} matrix 508 corresponds to the basis vectors (each row is a basis vector) utilized to perform compression in the FD. For the W_{f}^{H} matrix 508, the basis vectors can be derived, for example, from a certain number of columns in a discrete Fourier transform (DFT) matrix.

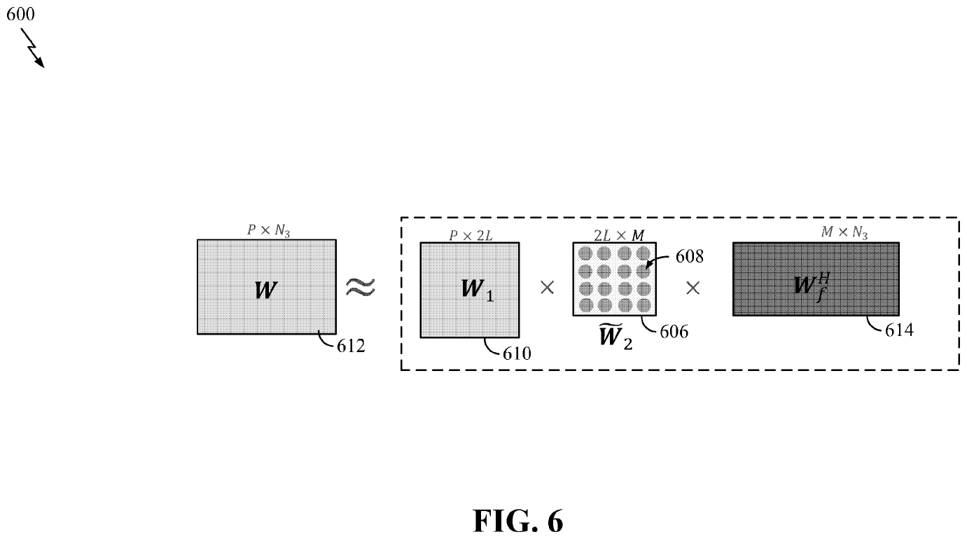

FIG. 6 is a schematic diagram illustrating a composition of an example precoding matrix 600 with frequency domain (FD) compression for a single layer transmission according to some aspects of this disclosure. In some examples, a base station (BS) 108 may implement the example precoding matrix 600 to precode a downlink (DL) communication utilizing multiple subbands, for example, in the single layer transmission. In some examples, the example precoding matrix W 612 represents a Type II precoding matrix composition for one layer. As in the previous example, the W₁ matrix 610 represents a spatial domain (SD) compression matrix. The W_{f}^{H} matrix 614 represents the frequency domain (FD) compression matrix. In the \tilde{W}₂ matrix 606, one row corresponds to one spatial beam (of 2L total beams) in W₁, and one element 608 (e.g., an entry, etc.) in the \tilde{W}₂ matrix 606 represents the coefficient of one tap for this spatial beam. The tap coefficient may correspond to a delay value, in some examples. An entry in the \tilde{W}₂ matrix 606 corresponds to a row of W_{f}^{H}.

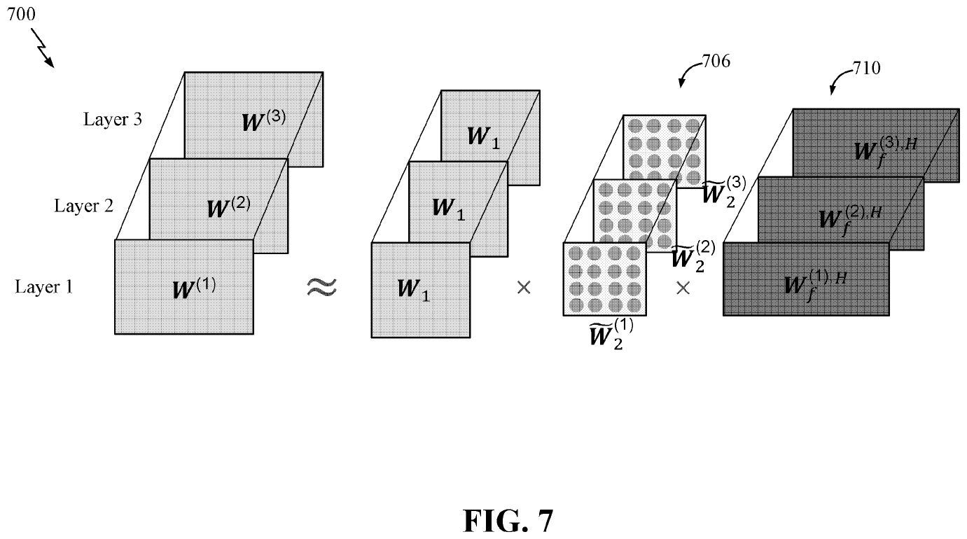

FIG. 7 is a schematic diagram illustrating a composition of an example precoding matrix for a multiple layer transmission according to some aspects of this disclosure. In some examples, a base station (BS) 108 may implement the example precoding matrix W 700 to precode a downlink (DL) communication utilizing multiple subbands, for example, in the multiple layer transmission (e.g., multiple data streams). In some examples, the example precoding matrix 700 represents a Type II precoding matrix composition for multiple layers. The \tilde{W}₂ matrix 706 corresponds to the linear combination coefficient component of the precoding matrix. In some examples, a row of the \tilde{W}₂ matrix 706 (e.g., a horizontal row of the matrix) corresponds to a beam of a particular transmission layer (e.g., ‘Layer 1’ has four rows representing four beams of the first transmission layer, ‘Layer 2’ has four rows representing four beams of the second transmission layer, etc.). Accordingly, an element (e.g., an entry) within a row may represent one delay value (e.g., a tap delay, a non-zero position, etc.) within that beam. In an example, an element within a given row can represent a tap coefficient, which may correspond to a delay value, in some examples.

### Issue

Massive MIMO in particular relies on accurate channel estimation to generate a suitable precoding matrix to map a transmission signal to its antennas. However, channel estimation can face several challenges that may limit its accuracy. Channel aging is one such challenge that can affect the accuracy of a channel estimate. That is, channel coefficients may change over time, caused by, for example, a moving user equipment (UE) 106 or for other reasons. At the time when a base station 108 applies a set of estimated channel coefficients (e.g., for precoding a downlink (DL) transmission), however, the time instant at which the base station 108 generated the set of channel coefficients has passed, potentially resulting in channel estimation error. Because massive MIMO demands significant and potentially time-consuming processing resources, the channel can experience substantial aging between the time when a base station generates a channel estimate and the time the base station uses the channel estimate for precoding. This issue is further exacerbated as modern networks use higher and higher frequencies for wireless communication (e.g., millimeter waves (mmW), etc.). That is, at high frequencies, the coherence time, or the time interval at which the channel estimate remains substantially flat or constant, is very low.

When a user equipment (UE) 106 moves with low speed, the value of Doppler frequency can be relatively small. In such instances, the channel response variance between two channel state information (CSI) reports may be relatively slow, providing a relatively small variance in channel response. In such instances, the reported CSI values may remain valid until the time instance of a subsequent CSI report.

When a UE 106 moves with high speed, the value of Doppler frequency is large. In such instances, the channel response variance between two CSI reports can be relatively large. Contrary to the example immediately above in which the UE 106 moves with low speed, in a scenario involving the UE 106 moving with high speed, the reported CSI values (RI/PMI/CQI) may become invalid (e.g., obsolete) before the base station 108 receives a subsequent CSI report. Accordingly, the throughput of a wireless communication may tend to degrade as the BS 108 utilizes invalid CSI values to precode downlink (DL) communications transmitted to the fast-moving UE 106.

The effect of the speed of the UE 106 on the value of Doppler frequency (e.g., relatively small or large) can be represented using the following Doppler frequency formula:

$${f}_{d} = \frac{{f}_{c} \cdot {v}_{UE} cos θ}{{v}_{light}} ,$$

where f_{c} is carrier frequency, v_{UE} is speed of the UE 106, v_{light} is the speed of light, θ is the angle between radio wave arrival direction and a moving direction of the UE 106. In an example, a UE 106 can be configured to transmit one or more Doppler frequency values f_{d} determined based on the Doppler frequency formula.

In some examples, such as with respect to a wideband MIMO channel model, the channel matrix, at time instance n and subcarrier k, can be represented as:

$$H ( n , k ) = {\sum }_{l = 0}^{L} {α}_{l} {u}_{l} {v}_{l}^{H} {e}^{- \frac{j 2 {πτ}_{l} k}{N}} {e}^{j 2 π {f}_{d , l} {t}_{n}} ,$$

where (a) uₗ, (b) vₗ, (c) τₗ and (d) f_{d,l} are, for path l (e.g., layer l): (a) the steering vector related to angle of arrival, (b) the steering vector related to angle of departure, (c) the delay, and (d) the Doppler frequency. In some examples, the steering vectors may include discrete Fourier transform (DFT) vectors. Because different paths may have different arrival directions, the values of {f_{d,l}} may be different. Additionally, the combination result of multiple paths may tend to vary with time. In an example, a higher v_{UE} may tend to increase the values of {f_{d,l}}. In any case, the higher values of {f_{d,l}} tend to result in a relatively faster (e.g., higher) variance in channel response H(n,k).

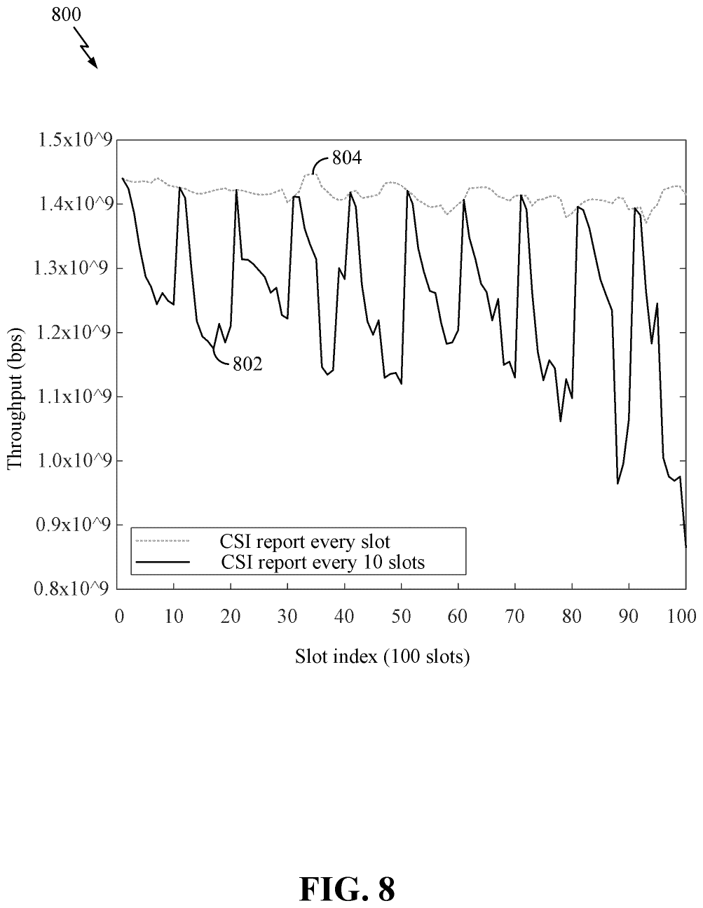

FIG. 8 is a chart 800 schematically illustrating an example of throughput degradation according to some aspects of this disclosure. The chart 800 illustrates an effect of channel aging according to one example. The illustration represents a throughput for a DL communication as a function of time, with time represented according to a sequence of slots. In a first Example 802 illustrated with a solid line, a BS 108 receives a CSI report once every ten slots. Due to channel aging during the course of the ten slots, the latest PMI becomes more poorly matched with the channel status causing a degradation in throughput. In a second Example 804 illustrated with a dashed line, a BS 108 receives a CSI report in every slot. With a fresh PMI every slot, there is not a substantial degradation of throughput over time. However, because reporting a CSI in every slot has a cost of additional signaling overhead, this example also suffers from a DL throughput reduction for user data or traffic.

The chart 800 illustrates a throughput (bits per second, bps) as a function of time, for every slot index according to some examples. In a first Example 802 illustrated with a solid line, a BS 108 receives a CSI report once every ten slots. For example, when a UE 106 is moving at high speeds while receiving CSI-RSs, the resulting CSI measurements reflected in a CSI report can quickly become invalid (e.g., due to channel aging, fading, etc.). This in turn causes throughput degradation until the BS 108 receives a fresh CSI report. The BS 108 may, thus, request more frequent CSI reports from the UE 106 (e.g., one CSI report per time slot). In a second Example 904 illustrated with a dashed line, a BS 108 receives a CSI report in every slot. With a fresh PMI every slot, there is not a substantial degradation of throughput overtime. However, because reporting a CSI in every slot has a cost of additional signaling overhead, this example also suffers from a DL throughput reduction for user data or traffic.

The obsolete CSI may be invalid in high-speed MIMO. In some examples, if CSI is reported every ten slots, the latest reported precoding matrix indicator (PMI) may tend to become unmatched with the current channel status as time elapses (as shown), and thus the throughput tends to degrade as a result. If CSI is reported every slot, the uplink (UL) signaling overhead may tend to be relatively high. In such instances, the downlink (DL) throughput may tend to degrade (e.g., be reduced) as a result.

### Transmitting Doppler Frequency Values and Corresponding Weight Values

In some examples, in high-speed MIMO scenarios, the UE 106 can be configured to measure a set of reference signals, such as a set of channel state information reference signals (CSI-RSs) at multiple time instances. The UE 106 accordingly determines a set of Doppler frequency values and a corresponding set of weight values (e.g., as part of the linear combination coefficients). In such examples, the UE 106 can be configured to determine, for each beam or for each delay value (e.g., on top of Rel-16 of 3GPP specifications for 5G NR eType-2 codebook): (i) a set of Doppler frequency values, and (ii) a corresponding set of weight values. The UE 106 transmits, to the BS 108: (i) the set of Doppler frequency values, and (ii) the corresponding set of weight values. In some examples, the UE 106 may include the set of Doppler frequency values and the corresponding set of weight values in a channel state information (CSI) report that the UE 106 transmits to the BS 108. In an example, the UE 106 may transmit the CSI report to the BS 108 in accordance with a timing parameter. The BS 108 may utilize a PMI prediction formula to determine (e.g., generate and/or update) a downlink (DL) precoding matrix that is based at least in part on the set of Doppler frequency values and the corresponding set of weight values.

In such examples, the BS 108 may determine, based on the set of Doppler frequency values and the corresponding set of weight values, a downlink (DL) precoding matrix with comparatively high accuracy. This, in turn, may increase throughput as an advantageous technical effect of utilizing a PMI prediction formula that incorporates a first set of Doppler frequency values and a corresponding set of weight values. The BS 108 may thus determine a DL precoding matrix (e.g., update its DL precoding matrix) with high accuracy for each subsequent slot until receiving a subsequent set of Doppler frequency values and a corresponding set of weight values. In particular, the BS 108 may do so regardless of whether the UE 106 is moving at a rate of speed conducive to causing relatively high Doppler frequency values, such as those calculated via the Doppler frequency formula provided herein, for example.

Moreover, the UE 106 and BS 108 may coordinate such efforts while maintaining the overhead of the UE 106 relatively low, for example, compared to instances where the UE 106 might have otherwise been transmitting at a relatively high frequency (e.g., one CSI report per reference signal the UE 106 receives). Rather, the UE 106 may advantageously reduce and/or condense the size of each CSI report that includes such Doppler frequency values and corresponding weight values in accordance with those configuration parameters described herein, and transmit such CSI reports at a lesser frequency without compromising accuracy at the BS 108 in determining a DL precoding matrix due to the resultant availability of valid CSI values for the PMI prediction formula to utilize.

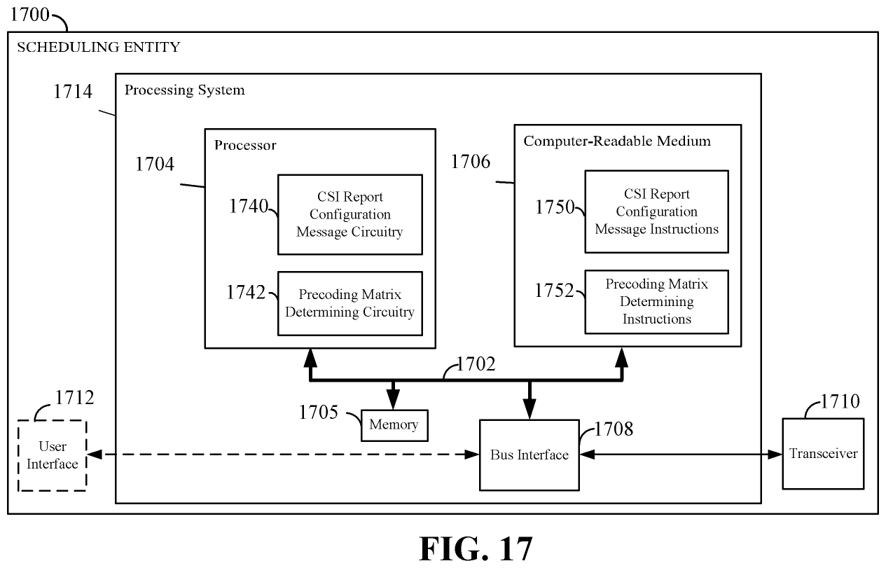

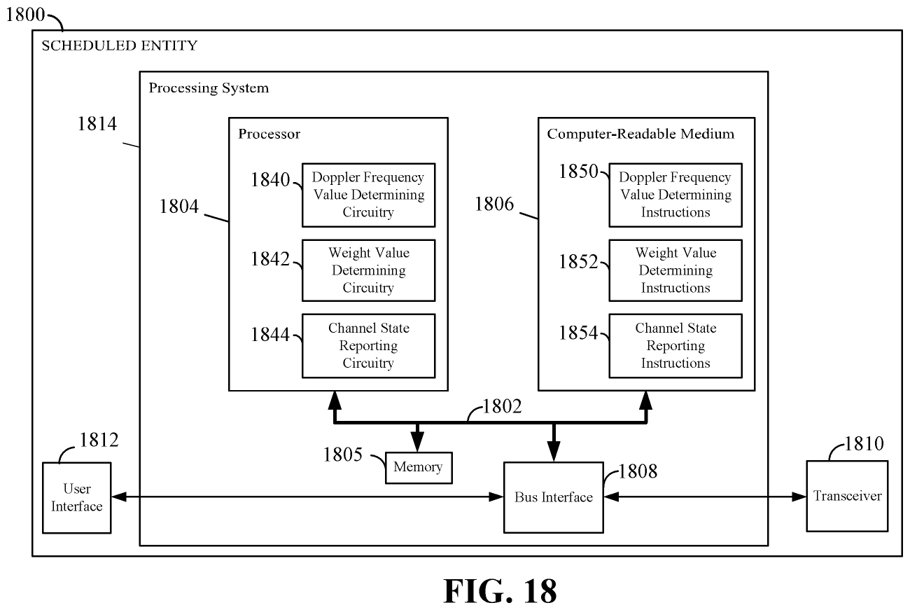

FIG. 9 is a flow chart illustrating an exemplary process 900 for communicating and utilizing Doppler frequency values and corresponding weight values, in accordance with some aspects of the present disclosure. In an example, a base station 108 (e.g., a base station (BS) 108, etc.) may transmit reference signals to a user equipment (UE) 106 (e.g., a UE 106), and receive a set of Doppler frequency values and a corresponding set of weight values from the UE 106. As described below, a particular implementation may omit some or all illustrated features, and may not require some illustrated features to implement all embodiments. In some examples, the scheduling entity 1700 illustrated in FIG. 17 and the scheduled entity 1800 illustrated in FIG. 18 may be configured to carry out corresponding portion of the process 900. In some examples, any suitable apparatus or means for carrying out the functions or algorithm described below may carry out the process 900.

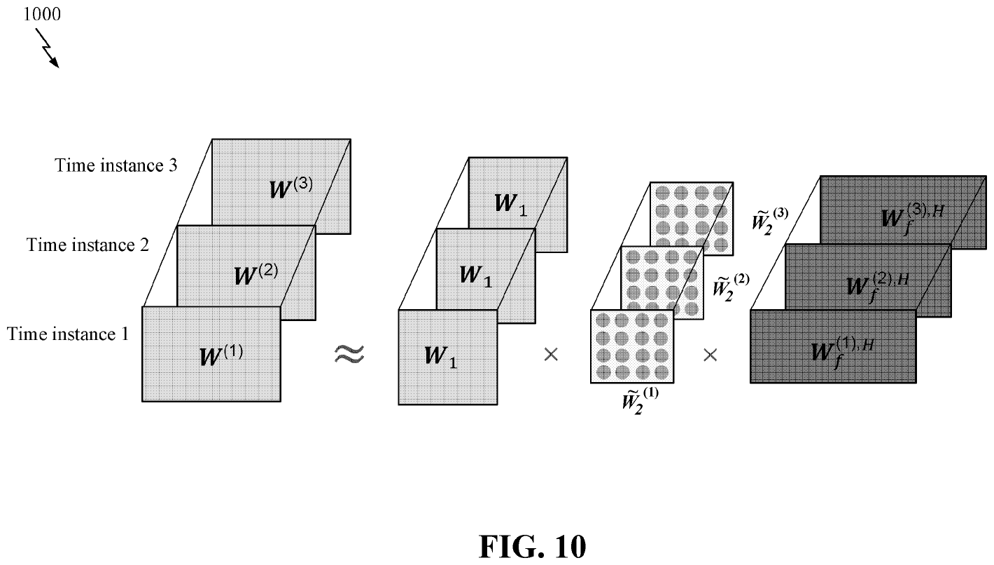

Blocks 902-914 represent an example of a BS 108 utilizing a DL channel estimate to determine a downlink (DL) precoding matrix and updating (e.g., refining, modifying, etc.) the DL precoding matrix based on PMI received from a UE 106. As will be illustrated, the BS 108 may advantageously update the DL precoding matrix over time. In an example, the BS 108 may do so based at least in part on: (i) a set of Doppler frequency values, and (ii) a corresponding set of weight values. The UE 106 may transmit such Doppler and corresponding weight information to the BS 108, for example, as described with reference to FIGS. 10-16.

At block 902, a base station (BS) 108 transmits, to a UE 106, a channel state information (CSI) report configuration message. In some examples, the CSI report configuration message instructs the UE 106 to transmit a CSI report after receiving multiple CSI-RSs (e.g., ten CSI-RSs received over ten slots). Additionally, the CSI report configuration message may instruct the UE 106 to include (e.g., as part of the CSI report) a set of Doppler frequency values obtained from measuring the CSI-RSs, and a set of weight values corresponding to the set of Doppler frequency values.

At block 904, the UE 106 receives the CSI report configuration message. In an example, the UE 106 may receive a CSI report configuration message that instructs the UE 106 to determine and transmit, to the BS 108, Doppler frequency values and weight values according to a set of parameters.

At block 906, the BS 108 transmits a first set of reference signals (e.g., one or more CSI-RSs) to a UE 106. In some examples, the BS 108 may transmit the first set of RSs to the UE 106 utilizing a downlink (DL) precoding matrix. In another example, the BS 108 may transmit the first set of RSs without any precoding. In an example, the BS 108 may transmit the CSI-RSs without precoding the RSs (e.g., as non-precoded RSs) as an initial set of RSs transmitted to the UE 106.

In optional block 908, the UE 106 receives the first set of RSs from the BS 108. The UE 106 may receive the first set of RSs as a CSI-RS using, for example, receive antennas 308.

In optional block 910, the UE 106 may transmit a channel state report, including precoding matrix indicator (PMI), to the BS 108. In such instances, the UE 106 may measure the first set of RSs to estimate the DL channel.

Utilizing UE feedback (e.g., a set of Doppler frequency values, and a corresponding set of weight values) may effectively improve precoder performance as described for the DL precoding matrix. In addition, the BS 108 may update the DL precoding matrix based on the set of Doppler frequency values and the corresponding set of weight values. In an example, the BS 108 may transmit a precoded DL reference signal over a set of antenna ports.

In optional block 906, the UE 106 may estimate the DL channel to determine PMI. In an example, the UE 106 may determine channel characteristics based on measurements performed on the first set of RSs. In such examples, the UE 106 may determine the PMI based on those characteristics of the DL channel.

In optional block 908, the UE 106 may transmit the PMI to the BS 108. In an example, the UE 106 may transmit a set of precoding matrix indicators or a precoding matrix to the BS 108.

In optional block 912, the BS 108 receives the PMI from the UE 106. The BS 108 may process the PMI to determine, for example, a frequency domain (FD) basis vector.

In optional block 914, the BS 108 may utilize the PMI to transmit a set of RSs to the UE 106. In such examples, when transmitting the set of RSs to the UE 106, the BS 108 may precode the set of RSs utilizing a downlink (DL) precoding matrix. The BS 108 may determine or update the DL precoding matrix based at least in part on the PMI. In addition, or alternatively, the BS 108 may utilize a codebook to determine the DL precoding matrix. In this way, the BS 108 may precode the set of RSs utilizing the DL precoding matrix to provide the UE 106 with a precoded set of RSs.

At block 916, the UE 106 receives the precoded set of RS(s) from the BS 108. In an example, the UE 106 may receive the precoded set of RS(s) over a plurality of antenna ports. The UE 106 may receive the precoded set of RS(s) over time, such that a subset of RS(s) corresponding to individual antenna ports are received across multiple time instances.

At block 918, the UE 106 calculates, for each CSI-RS, a linear combination coefficient component of a precoding matrix. The UE 106 identifies each non-zero position of the linear combination coefficient component of the precoding matrix. In such examples, each non-zero position indicates a delay value (e.g., that corresponds to a tap coefficient). A delay value corresponds to a beam (e.g., a precoding beam), and each beam corresponds to a transmission layer in a DL communication (e.g., a DL transmission).

The UE 106 may calculate the Doppler frequency values for each delay value in high-speed MIMO scenarios. To calculate Doppler frequency values, the UE 106 may calculate, for each CSI-RS time instance, the precoding matrix components W₁, \tilde{W}₂^{(t)} and W_{f}^{H}. In all CSI-RS time instances, the values of W₁, W_{f}^{H}, and the non-zero positions in \tilde{W}₂^{(t)} are common. For each non-zero position in \tilde{W}₂^{(t)} (associated with a delay value of a beam of a transmission layer), the UE 106 calculates, one or more Doppler frequency values {f_{l,b,d,n}^{(Doppler)}}_{n=1˜N} and weight values {α_{l,b,d,n}^{(Doppler)}}_{n=1˜N} for layer l, beam b and delay d, based on vector [w_{i,j}⁽¹⁾, w_{i,j}⁽²⁾, . . . , w_{i,j}^{(T)}], where w_{i,j}^{(t)} generally refers to the (i,j)th element in \tilde{W}₂^{(t)}. In addition, or alternatively, for each non-zero position in \tilde{W}₂^{(t)} (associated with a delay value of a beam of a layer), the UE 106 calculates weight values {α_{l,b,d,n}^{(Doppler)}}_{n=1˜N} for layer l, beam b, and delay d.

The optimal objective for the UE 106 is for the UE 106 to minimize the value of

$${\sum }_{t = 1}^{T} {‖ {w}_{i , j}^{( t )} - {w}_{i , j}^{( 1 )} {\sum }_{n = 0}^{N} {α}_{n}^{( Doppler )} {e}^{j 2 π {f}_{n}^{( Doppler )} t} ‖}_{2}^{2}$$

The value of T can be the number of CSI-RS time instances in one CSI-RS report period. In some examples, however, the UE 106 may determine the value of T. Accordingly, the UE 103 may determine a value for T to be the same or different relative to the number of CSI-RS time instances in one CSI-RS report period. In an example, FIG. 10 is a schematic diagram 1000 illustrating a composition of an example precoding matrix for a single layer and multiple time instances according to some aspects of this disclosure. That is, the precoding matrix relates to multiple time instances (e.g., time instance 1, time instance 2, time instance 3, etc.) for one transmission layer. In some examples, the value of T corresponds to the number of CSI-RS time instances. In another example, the UE 106 may determine the value of T as being less than the number of CSI-RS instances in one CSI-RS period. The UE 106 may be configured to utilize a value of T (determined as such), for example, to conserve processing resources by potentially reducing calculation complexity, in some instances.

Returning to block 918, the UE 106 may utilize any number of different optimization algorithms to determine the set of Doppler frequency values and the corresponding set of weight values. In an example, the UE 106 may utilize MUltiple SIgnal Classification (MUSIC) algorithms, compressive sensing algorithms and machine learning (ML) algorithms, and so forth.

Based on the CSI report configuration message, the UE 106 utilizes the configured CSI format to transmit, to the BS 108: (i) the set of Doppler frequency values {f_{l,b,d,n}^{(Doppler)}}_{l,b,d,n}, and (ii) the corresponding set of weight values {α_{l,b,d,n}^{(Doppler)}}_{l,b,d,n}. In addition, or alternatively, the UE 106 may report the legacy PMI based on eType-2 codebook (W₁, \tilde{W}₂, W_{f}^{H}).

At block 920, the BS 108 receives the set of Doppler frequency values. In addition, or alternatively, the BS 108 may receive the set of weight values that correspond to a set of Doppler frequency values. In some examples, the BS 108 may receive the set of Doppler frequency values and/or the corresponding set of weight values in a channel state report. In another example, the BS 108 may receive the set of Doppler frequency values and/or the corresponding set of weight values separate from a channel state report. In addition, or alternatively, the BS 108 may receive the set of Doppler frequency values separate from the corresponding set of weight values. In an example, the BS 108 may receive the set of Doppler frequency values at a first time instance and may receive the corresponding set of weight values in a second time instance that comes before or after the first time instance.

At block 922, the BS 108 updates the downlink (DL) precoding matrix based at least in part on the set of Doppler frequency values and the corresponding set of weight values. The BS 108 utilizes the set of Doppler frequency values and the corresponding set of weight values to improve its generation of a downlink (DL) precoding matrix. The BS utilizes a precoding matrix indicator (PMI) prediction formula to determine the DL precoding matrix to precode each DL communication (e.g., each DL transmission) in a set of DL communications before receiving, from the UE 106, a next CSI report.

In such examples, the BS 108 determines a downlink (DL) precoding matrix for precoding a DL communication (e.g., DL data) to transmit a precoded DL communication to the UE 106. The base station (BS) 108 applies a channel prediction algorithm to determine and/or update a downlink (DL) precoding matrix for precoding DL communications. In some examples, the BS 108 may do so in order to generate a downlink (DL) precoding matrix for each DL communication (e.g., for each slot) based on the set of Doppler frequency values and the corresponding set of weight values (e.g., obtained via the first CSI report).

In an example, the BS 108 may utilize the received set of Doppler frequency values and the corresponding set of weight values to determine the precoding matrix W_{T′}. In such instances, the BS 108 may determine the precoding matrix for the slot having a timing gap of T′ measured relative to the time instance of the latest CSI report (e.g., the first CSI report).

W_{T′}=W₁\tilde{W}₂^{(T′)}W_{f}^{H}

In some examples, the BS 108 can be configured to determine, from the CSI report, the W₁ matrix and/or the W_{f}^{H} matrix. In addition, or alternatively, the BS 108 may determine \tilde{W}₂^{(T′)} based on: a received \tilde{W}₂ matrix, the set of Doppler frequency values, and/or the corresponding set of weight values that correspond to the set of Doppler frequency values. In such examples, the BS 108 may utilize the precoding matrix formula that incorporates the set of Doppler frequency values and the corresponding set of weight values. The BS 108 may assume the value of the (b,d)th element in the latest \tilde{W}₂ matrix of layer l is w_{l,b,d}^{(CSI)}. In such instances, the BS 108 may determine the value of the (b,d)th element in \tilde{W}₂^{(T′)} according to the following precoding matrix formula:

$${w}_{l , b , d}^{( {T}^{′} )} = {w}_{l , b , d}^{( CSI )} {\sum }_{n = 1}^{N} {α}_{l , b , d , n}^{( Doppler )} {e}^{j 2 π {f}_{l , b , d , n}^{( Doppler )} {T}^{′}}$$

In some examples, the precoding matrix determining circuitry 1842 of FIG. 17 may employ this equation to determine a precoding matrix. In an example, the BS 108 may determine the precoding matrix at time [n+1] according to the precoding matrix formula.

At block 924, the BS 108 utilizes the updated downlink (DL) precoding matrix to precode subsequent DL communications to the UE 106. In an example, the BS 108 utilizes the updated DL precoding matrix to transmit a precoded set of reference signals to the UE 106. In some examples, the BS 108 may update the DL precoding matrix at each time instance of transmitting a reference signal to the UE 106.

At block 926, the UE 106 receives the precoded downlink communication from the BS 108. In some examples, the precoded DL communication includes precoded DL data (e.g., transmitted via a PDSCH). In another example, the precoded DL communication includes a subsequent set of reference signals precoded via the updated DL precoding matrix. In such examples, the UE 106 receives the precoded set of RSs (e.g., CSI-RSs) from the BS 108. The UE 106 may determine, from the precoded set of RSs, a second set of Doppler frequency values and a second set of weight values corresponding to the second set of Doppler frequency values. That is, the UE 106 may transmit, based at least in part on the precoded set of RSs, a second set of Doppler frequency values, and a second set of weight values corresponding to the second set of Doppler frequency values, to the BS 108.

In optional block 928, the BS 108 may receive, from the UE 106, the additional Doppler frequency values corresponding to the precoded DL communication. In an example, the BS 108 may receive, from the UE 106, the second set of Doppler frequency values, and the second set of weight values corresponding to the second set of Doppler frequency values.

This process 900 may be repeated any number of times to dynamically maintain a suitable level of DL precoder performance.

### Channel State Information (CSI) Report Configuration Message—Timing Parameter

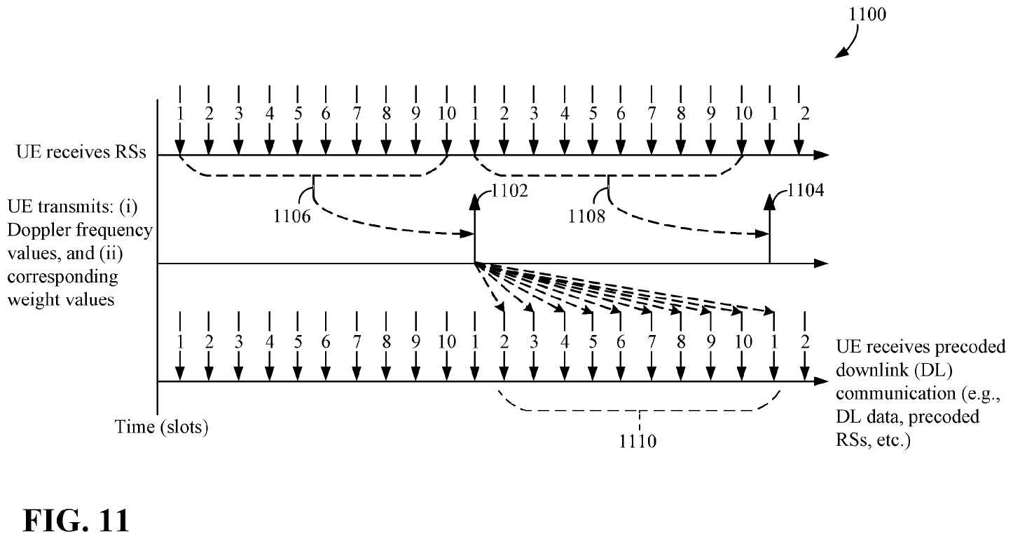

FIG. 11 is a timing diagram 1100 illustrating an example of a process for a UE 106 to transmit a set of Doppler frequency values and a corresponding set of weight values according to some examples. In the case of periodic or semi-persistent channel state information (CSI) reports, to reduce CSI report overhead, the BS 108 can configure the report period for transmitting CSI reports to be larger than the CSI-RS transmission period of CSI-RSs (e.g., the period of CSI report may be ten times that of the period of CSI-RSs transmissions). In the case of aperiodic CSI reports, multiple time instances of CSI-RSs (e.g., a first set of reference signals) may correspond to a single CSI report (e.g., a first CSI report 1102).

Upon receiving a set of CSI-RSs (e.g., ten CSI-RSs transmitted over a ten slot duration), the UE 106 may be configured to calculate a set of Doppler frequency values and a corresponding set of weight values based on the set of CSI-RSs (e.g., a duration of CSI-RSs). In an example, a first report period 1106 may include a first set of CSI-RSs (e.g., five CSI-RSs, eight CSI-RSs, ten CSI-RSs, etc.) transmitted over a first predetermined slot duration (e.g., a five-slot duration, an eight-slot duration, a ten-slot duration, etc.). In another example, a second report period 1108 may correspond to a second set of CSI-RSs the BS 108 transmits over a second predetermined slot duration, where the first slot duration and the second slot duration may be different or may be the same.

In some examples, the UE 106 may receive a channel state information (CSI) report configuration message (not explicitly shown in FIG. 11), the CSI report configuration message including a timing parameter for the transmitting of the set of Doppler frequency values, the set of weight values, or both the set of Doppler frequency values and the set of weight values. In some examples, the CSI report configuration message may determine a frequency with which the UE 106 transmits each CSI report and/or defines the way in which the UE 106 determines and/or reports (e.g., via the CSI report(s)) a set of Doppler frequency values and/or the corresponding set of weight values. In an illustrative and non-limiting example, a BS 108 may configure a UE to transmit a CSI report every ten slots.

In some examples, the CSI report configuration message received by the UE 106 includes a set of channel state information (CSI) report parameters. In such examples, the CSI report parameters may include the timing parameter. In some examples, transmitting the set of Doppler frequency values and the set of weight values may include the UE 106 transmitting, according to the timing parameter, a CSI report 1102. In such instances, the CSI report 1102 may include at least one of: (i) the set of Doppler frequency values, and/or (ii) the corresponding set of weight values.

In some examples, the UE 106 may determine, from the CSI report configuration message, a report period. The report period may, in some examples, correspond to the timing parameter. In another example, the report period may define a threshold number of reference signals (e.g., for a first set of reference signals, a second set of reference signals, etc.) for one or more report period(s) (e.g., a first report period 1106, a second report period 1108, etc.). In addition, or alternatively, the report period may define a length of time for the receiving of the set of reference signals. In such instances, the UE 106 may transmit the set of Doppler frequency values and the corresponding set of weight values according to the report period. The report period may be based at least in part on the timing parameter, in such examples. In another example, the report period may be based on an allocation of communication resources, such as a set of allocated symbols, a set of reference signal slots, etc.). As such, the UE 106 may determine, from the configuration message, an allocation of communication resources for receiving the set of reference signals (e.g., over a predefined report period). In such examples, the UE 106 may receive, via the allocation of communication resources, the set of reference signals to determine the set of Doppler frequency values and corresponding weight values for a given report period (e.g., a ten-slot duration per report period, a five-slot duration per report period, etc.).

As described with reference to block 918 of FIG. 9, the UE 106 may transmit, to the BS 108, a set of the Doppler frequency values and a corresponding set of weight values. In an example, the UE 106 may include the set of the Doppler frequency values and a corresponding set of weight values in a first CSI report 1102. The UE 106 may transmit the first CSI report 1102 to the BS 108 at a first report time instance (T). In some instances, the UE 106 may apply additional CSI format parameters to configure the CSI report. For example, the UE 106 may quantize the Doppler frequency values in accordance with a quantization parameter. In another example, the UE 106 may quantize channel coefficients, in addition to, or alternatively from, quantizing such Doppler frequency values.

In some examples, the BS 108 determines and/or updates, based on the set of Doppler frequency values and corresponding set of weight values, a downlink (DL) precoding matrix (not explicitly shown). The BS 108 may determine the DL precoding matrix for a subsequent set of slots (starting with slot #2 in this example). The BS 108 may determine the DL precoding matrix for each slot for the subsequent set of slots. In instances where the BS 108 receives a CSI report 1102 that includes a set of Doppler frequency values and corresponding set of weight values, the BS 108 may determine the DL precoding matrix for precoding DL communications corresponding to each of the following slots (e.g., a subsequent set of slots), and the BS 108 may do so until the arrival of a next CSI report 1104. In an illustrative and non-limiting example, the BS 108 may determine the DL precoding matrix for each slot of the ten slots following the BS 108 receiving the first CSI report 1102.

The BS 108 utilizes the set of Doppler frequency values in precoding matrix determination. The BS 108 determines the precoding matrix (as described above with reference to FIG. 9 for example) for each slot respectively, until the arrival of the next CSI report 1104. By transmitting the set of Doppler frequency values (and the corresponding set of weight values) to the BS 108, the BS 108 can be configured to determine the suitable dedicated precoding matrix for each of the subsequent slots (e.g., starting with slot #2 of the second report period in this example). In such examples, the UE 106 may receive a precoded set of downlink (DL) communications (e.g., DL data, precoded RSs, etc.). In such examples, the precoded set of DL communications may be precoded based at least in part on the set of Doppler frequency values and the corresponding set of weight values according to one or more of the various techniques of this disclosure. That is, the BS 108 may precode a set of DL communications 1110 based at least in part on the set of Doppler frequency values and the corresponding set of weight values. In addition, or alternatively, the BS 108 may precode the second set of RSs starting with slot #2 (e.g., a second CSI-RS) of a subsequent report period (e.g., the second report period 1108).

Accordingly, the BS 108 may improve the performance (e.g., accuracy) of the downlink (DL) precoding matrix in instances where a UE 106 is traveling at relatively high speeds. In addition, or alternatively, the BS 108 may be configured to provide a long report period of CSI reports. In an example, the CSI report period may include multiple instances of CSI-RS transmissions for each CSI report transmitted to the BS 108 in a given CSI report period. In such examples, the UL signaling overhead can be reduced at the UE 106, and as such, throughput may be increased. That is, one or more of the various techniques of this disclosure may advantageously increase throughput, as well as a decrease UE overhead, at the UE 106, while advantageously improving performance of the DL precoding matrix at the BS 108.

In some examples, the UE 106 may receive, in accordance with the CSI report configuration message, a second set of reference signals subsequent to the transmitting of the set of Doppler frequency values. In such instances, the second set of reference signals may include a precoded set of reference signals. Accordingly, the BS 108 may precode the set of reference signals based at least in part on: (i) the set of Doppler frequency values, and (ii) the corresponding set of weight values. In such examples, the UE 106 may transmit, in accordance with the CSI report configuration message, one or more additional Doppler frequency values corresponding to the second set of reference signals. The UE 106 may, in addition or alternatively, transmit one or more additional weight values corresponding to the one or more additional Doppler frequency values.

### Channel State Information (CSI) Report Configuration Message—Size Parameter

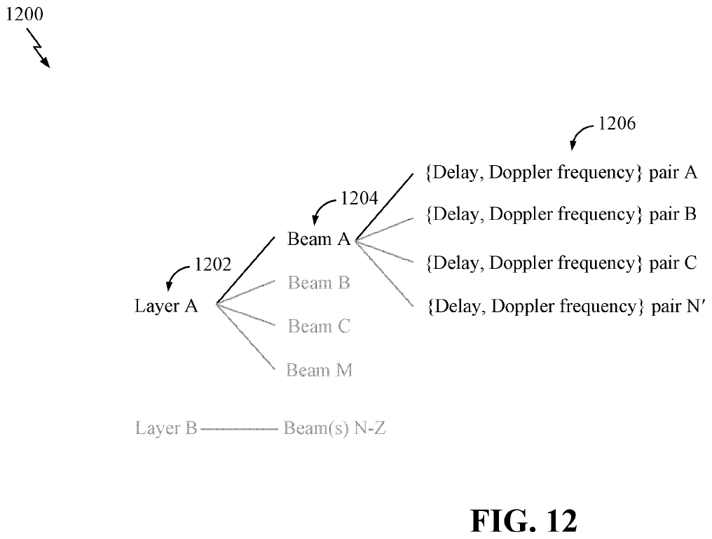

As shown in FIGS. 12-14, the base station (BS) 108 may configure the user equipment (UE) 106 to transmit precoding matrix indicator (PMI) for two transmission layers, four beams for each transmission layer, and two delay values for each beam (e.g., via legacy eType-2 codebook in Rel-16 of 3GPP specifications for 5G NR). In such examples, the UE 106 may transmit, for each beam or for each delay value (e.g., for each non-zero position): (i) the set of Doppler frequency values, and (ii) the corresponding set of weight values. The UE 106 may transmit the set of Doppler frequency values and the corresponding set of weight values in a channel state information (CSI) report.

FIG. 12 is a schematic diagram illustrating a beam of a layer according to some aspects of this disclosure. In an example, a beam may correspond to a set of delay-Doppler value pairs. In case of high-speed scenario, the BS 108 indicates, via a CSI report configuration message, for the UE 106 to transmit delay values and Doppler frequency values for the precoding vector of each beam. Therein, the BS 108 configures the CSI report format related to the set of Doppler frequency values and the corresponding set of weight values.

In some examples, the BS 108 may transmit a set of reference signals to the UE 106. In such examples, the set of reference signals may correspond to a first beam 1204 of a plurality of beams. The beams, in such instances, may correspond to a first transmission layer 1202 of a plurality of transmission layers. In some examples, the UE 106 may be configured (e.g., via the CSI report configuration message) to transmit PMI for two transmission layers, four beams for each layer, and ‘N′’ delay-Doppler value pairs 1206 for each beam.

In some examples, the BS 108 may indicate, via the CSI report configuration message, the CSI format regarding Doppler frequency values. The BS 108 may configure the UE 106 to report (e.g., up to) N′=4 {delay value, Doppler frequency value} pairs for each beam (e.g., a first delay value associated with a first Doppler frequency value in a first value pair, etc.). In some examples, the BS 108 configures a threshold size of a transmitted {delay value, Doppler frequency value} pair set (N′) (e.g., a size-delimited number of value pairs applicable to a given CSI report). In an example, the CSI report configuration message may include a threshold number of {delay value, Doppler frequency value} pairs not to exceed ‘N′’ value pairs in a single CSI report. In an example, the CSI report configuration message may instruct the UE 106 to transmit a size-delimited number of (e.g., no more than) N′=4 {delay value, Doppler frequency value} pairs for each beam (e.g., four delay-Doppler value pairs for a first Beam A).

The delay value or Doppler frequency value in any two delay-Doppler value pairs can be the same or different. In an illustrative example, delay-Doppler value ‘pair A’ and delay-Doppler value ‘pair B’ can have the same delay value or different delay values (as between the two value pairs), and/or the two value pairs can have the same Doppler frequency value or different Doppler frequency values (as between the two value pairs).

For each beam, the UE 106 may determine: a set of delay value and Doppler frequency value pairs (e.g., delay-Doppler value pairs). In some examples, the UE 106 can be configured to associate one beam's precoding vector with a set of {delay value, Doppler frequency value} pairs (e.g., delay-Doppler value pairs). In such examples, the UE 106 may associate each Doppler frequency value of the set of Doppler frequency values with at least one delay value of the set of delay values (e.g., paired with a corresponding delay value of the set of delay values).

In some instances, the CSI report configuration message may limit the size of the CSI report by limiting, for each beam of a DL communication (e.g., a DL transmission), the number of delay-Doppler value pairs the UE 106 may include in the CSI report. In such examples, the UE 106 may transmit the set of Doppler frequency values by applying a size-delimiting parameter defining a threshold number of delay-Doppler value pairs.

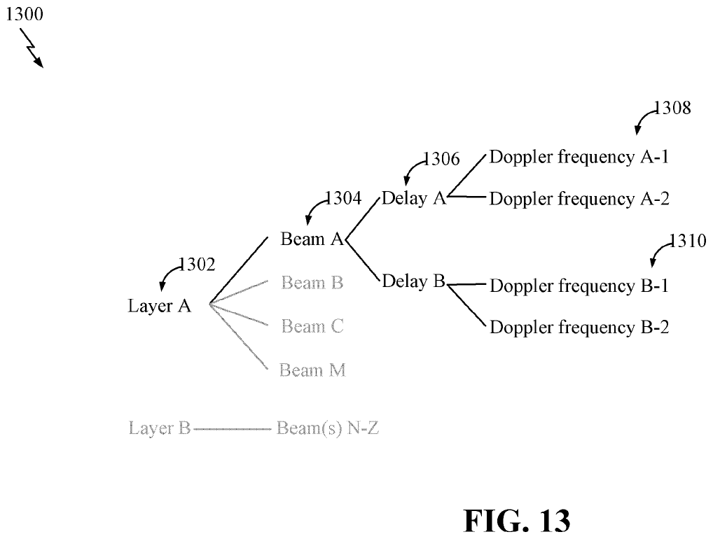

FIG. 13 is a schematic diagram 1300 illustrating a delay value of a beam corresponding to a set of Doppler frequency values according to some aspects of this disclosure. The UE 106 may transmit, based at least in part on the set of reference signals, a set of delay values 1306 that corresponds to the first beam 1304.

The BS 108 may indicate the CSI format regarding Doppler frequency values in the CSI report configuration message. In an example, the CSI format regarding Doppler frequency may include a threshold number of Doppler frequency values in the set of Doppler frequency values instructing the UE 106 not to exceed ‘N’ Doppler frequency values for each delay value. In an example, the BS 108 configures the UE 106 to transmit (e.g., up to) N=2 Doppler frequency values for each delay value.

In some examples, the UE 106 can be configured, via the CSI report configuration message, to transmit PMI for B Layers (e.g., B≤2), M Beams for each Layer (e.g., M≤4), and B Delay values for each Beam (B≤2), and N Doppler frequency values (quantized or not) for each Delay value (e.g., N=2, N=less than the number of transmission layers 1302, delay values 1306, etc., etc.). In such examples, the UE 106 may associate each delay value of the set of delay values with at least one Doppler frequency value of the set of Doppler frequency values (e.g., Doppler frequency values 1308 corresponding to Delay A, Doppler frequency values 1310 corresponding to Delay B, etc.).

In some examples, the UE 106 may determine a set of Doppler frequency values for each delay value for a size-delimited set of delay values. Here, the CSI report configuration message may instruct the UE 106 to limit the size of the CSI report by limiting the number of delay values the UE 106 may include within a given CSI report and the number of Doppler frequency values the UE 106 is to include within the CSI report (e.g., within a set of Doppler frequency values). In one example, the BS 108 configures, via the CSI report configuration message, the size of reported delay value set (D) and/or the size of a transmitted set of Doppler frequency values (N).

In some examples, the UE 106 can be configured to associate one beam's precoding vector with a set of delay values. Then, the UE 106 associates each delay value with a set of Doppler frequency values. In such examples, the UE 106 may transmit the set of Doppler frequency values by applying a size-delimiting parameter defining a threshold number of Doppler frequency values.

In some examples, associating a beam's precoding vector with a set of delay-Doppler value pairs (e.g., FIG. 12) provides higher flexibility compared to associating the beam's precoding vector with a set of delay values (e.g., FIG. 13). Associating the beam's precoding vector with a set of delay-Doppler value pairs, however, may in some instances, cost more reported bits relative to associating the beam's precoding vector with a set of delay values.

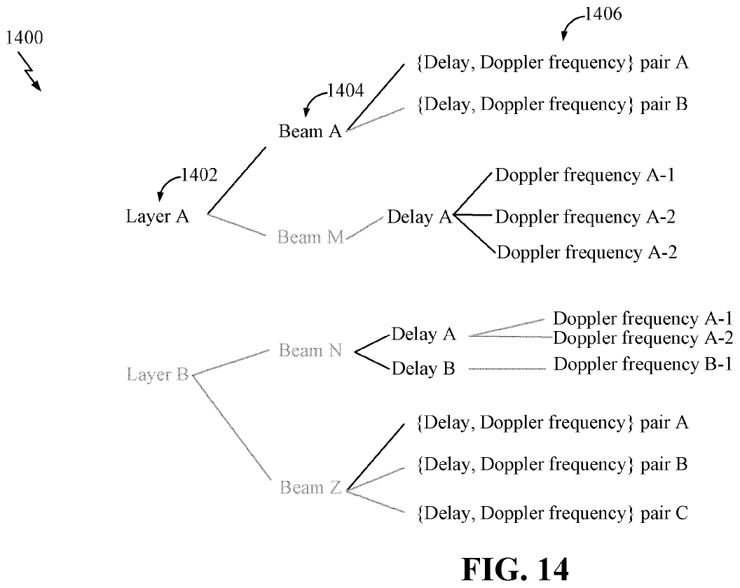

FIG. 14 is a schematic diagram illustrating a combination of delay-Doppler value pairs, as well as delay values corresponding to Doppler frequency values in unpaired configurations, according to some aspects of this disclosure. In an illustrative and non-limiting example, the UE 106 may transmit, according to the size parameter, PMI for two transmission layers 1402, four beams 1404 for each transmission layer, and two delay values for each beam, and/or four delay-Doppler value pairs for each beam. In some examples, the BS 108 may, in the CSI configuration message, combine: size-delimiting parameters corresponding to delay-Doppler value pairs (e.g., parameters limiting a number of delay-Doppler value pairs 1406 for a CSI report) with size-delimiting parameters corresponding to delay values and/or Doppler frequency values in unpaired configurations (e.g., unpaired delay values and unpaired Doppler frequency values, transmitted to a BS 108 as such, for a CSI report).

### Channel State Information (CSI) Report Configuration Message—Quantization Parameter

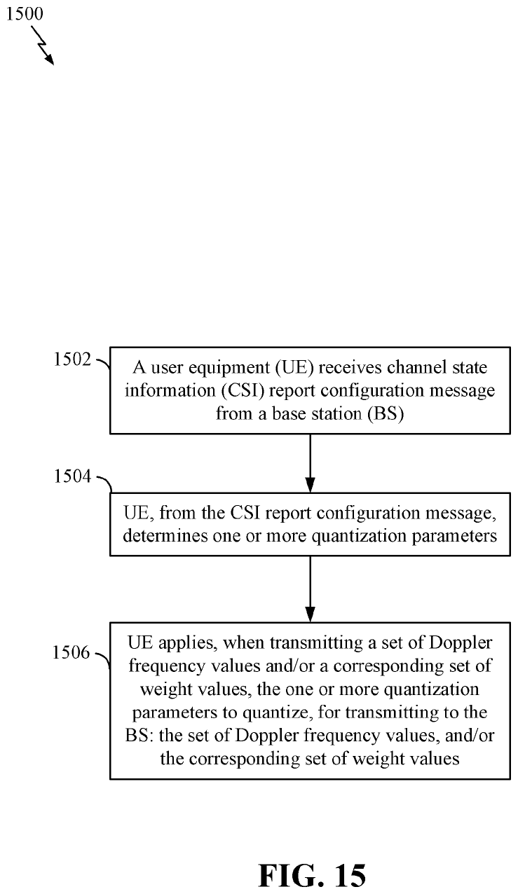

FIG. 15 is a flow chart illustrating an example of a process for determining quantization parameters for quantizing Doppler frequency values and/or corresponding weight values according to some aspects of this disclosure. In some examples, the UE 106 may quantize, according to the CSI report configuration message, the set of Doppler frequency values and/or the corresponding set of weight values.

At block 1502, the UE 106 may receive a CSI report configuration message from a BS 108. The CSI report configuration message may include one or more various parameters (e.g., commonality parameters, timing parameters, quantization parameters, size-delimiting parameters, etc.).

At block 1504, the UE 106 may determine, from the CSI report configuration message, a quantization parameter for quantizing: the set of Doppler frequency values, and/or the corresponding set of weight values.

At block 1506, the UE 106 may quantize each Doppler frequency value in the set of Doppler frequency values. In such examples, the UE 106 quantizes the calculated frequency values to yield a quantized set of Doppler frequency values. That is, the UE 106 may apply, when transmitting the set of Doppler frequency values and/or a corresponding set of weight values, the one or more quantization parameters to quantize, for transmitting to the BS 108: (i) the set of Doppler frequency values, and/or (ii) the corresponding set of weight values.

In an example, the UE 106 may utilize a quantization technique for quantizing the set of Doppler frequency values based on a maximum Doppler frequency: fₘₐₓ^{(Doppler)}. In such examples, the UE 106 may report a relative Doppler frequency value x in accordance with the equation as follows:

$${f}_{l , b , d , n}^{( Doppler )} = x \cdot {f}_{max}^{( Doppler )} ,$$

where the BS 108 can be configured to determine the value of fₘₐₓ^{(Doppler)}, and x is chosen from a regulated or configured set, e.g.,

$$\{ \frac{1}{16} , \frac{2}{16} , … , \frac{15}{16} , 1 \}$$

with 4-bits quantization. To determine this maximum Doppler frequency value: fₘₐₓ^{(Doppler)}, the BS 108 calculates:

$${f}_{max}^{( Doppler )} = \frac{{f}_{c} \cdot {v}_{UE , max}}{{v}_{light}}$$

based on the carrier frequency f_{c} and maximum speed of the UE 106: v_{UE,max}.

In another example, the UE 106 may utilize a quantization technique for quantizing the set of Doppler frequency values based on the period of reference signal transmissions (e.g., the timing gap between the transmission of two consecutive reference signals). In such instances, the UE 106 may report a relative Doppler frequency value x in accordance with the equation as follows:

$${f}_{l , b , d , n}^{( Doppler )} = x \cdot \frac{1}{{T}_{CSI - RS}} ,$$

where T_{CSI-RS} is the period of CSI-RS transmissions (e.g., the timing gap between two CSI-RS instances), which the BS 108 configures the report period in the CSI-RS configuration.

In addition, or alternatively, the UE 106 may utilize a quantization technique for quantizing the set of Doppler frequency values based on the timing duration length of all CSI-RS instances in one CSI report period. In such instances, the UE 106 may report a relative Doppler frequency value x in accordance with the equation as follows:

$${f}_{l , b , d , n}^{( Doppler )} = x \cdot \frac{1}{{T}_{CSI - RS}} ,$$

where D_{CSI-RS} is the timing duration length of all CSI-RS instances (e.g., ten slot duration) in one CSI report period (e.g., the first CSI report period 1106 of FIG. 11). In such examples, the BS 108 may configure the CSI report period in the CSI report configuration message.

In addition, or alternatively, the UE 106 may quantize the amplitude and phase of each weight value (e.g., in a set of weight values corresponding to a first report period 1106). In an example, the UE 106 may quantize the amplitude of each weight value, for a set of weight values, with a regulated set. In another example, the UE 106 may quantize the phase of each weight value, for the set of weight values, with a configured limited set. In such instances, the UE 106 may transmit a quantized set of weight values to the BS 108. Accordingly, the BS 108 may receive the weight values as a quantized set of weight values.

In some examples, a UE 106 may quantize one or both of the sets of values (e.g., the set of delay values and/or the set of Doppler frequency values) prior to configuring such values into value pairs (e.g., in instances where the UE 106 is configured to transmit the Doppler frequency values in delay-Doppler value pairs). In an example, the UE 106 may quantize a delay value r to determine a delay value integer with ┌log₂ N₃┐bits. In such examples, N₃ generally represents the number of subbands for a particular transmission.

In such examples, the UE 106 may associate a quantized delay value with a quantized Doppler frequency value to determine a delay-Doppler value pair. Accordingly, the UE 106 may transmit a set of delay-Doppler value pairs. That is, the UE 106 may be configured (e.g., via the CSI report configuration message) to quantize the delay values and Doppler frequency values when configuring the set of delay-Doppler value pairs for transmission (e.g., in a CSI report). In some examples, a CSI report may include: a quantized set of delay-Doppler value pairs, or a quantized set of delay values in an unpaired configuration along with a quantized set of Doppler frequency values in an unpaired configuration, and/or may include a quantized set of weight values, as well. In an example, the weight values represented by the quantized set of weight values may correspond to Doppler frequency values represented in the quantized set of delay-Doppler value pairs.

### Channel State Information (CSI) Report Configuration Message—Commonality Parameter

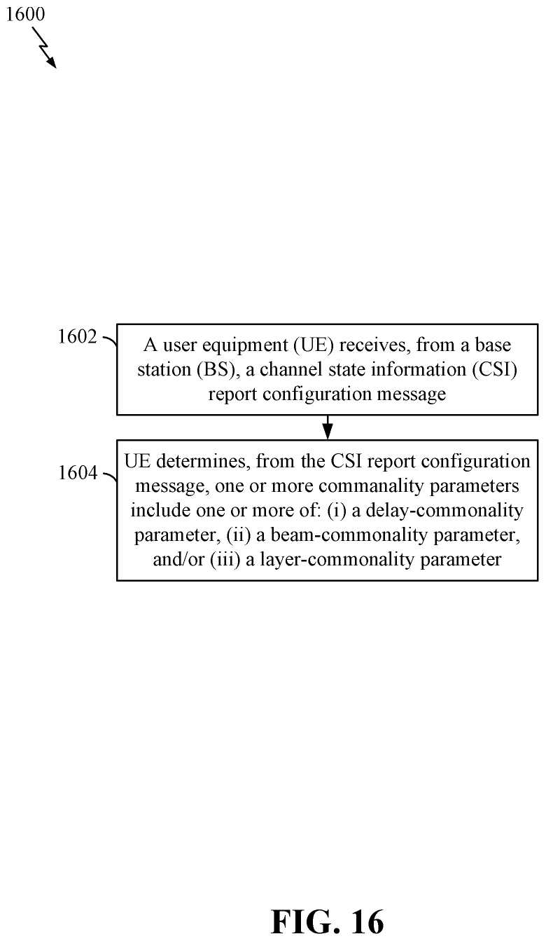

FIG. 16 is a flow chart illustrating an example of a process for determining one or more commonality parameters from a channel state information (CSI) report configuration message according to some aspects of this disclosure.

In an example, a set of delay values may correspond to one beam (e.g., a first beam of a first transmission layer). In some examples, the set of delay values that correspond to one beam may represent independent Doppler frequency values (e.g., different frequency values relative to each other value that corresponds to the beam). The reported bits in this case, however, may be relatively high yielding increased overhead for the user equipment (UE) 106. To reduce overhead for the UE 106 in transmitting the set of Doppler frequency values, a base station (BS) 108 can further configure one or more commonality parameters for the set of Doppler frequency values.

In an example, the BS 108 may transmit a set of one or more commonality parameters to the UE 106. The BS 108, in some instances, may transmit the set of commonality parameters to the UE 106 as part of the channel state information (CSI) report configuration message that the BS 108 transmits to the UE 106.

At block 1602, the UE 106 may receive, from the BS 108, the CSI report configuration message. The channel state report configuration message may include a set of one or more commonality parameters.

At block 1604, the UE 106 may determine, from the CSI report configuration message, one or more commonality parameters. In an example, the UE 106 may determine a set of one or more commonality parameters (e.g., Doppler frequency commonality parameters). In such examples, the UE 106 may apply the set of commonality parameters to the set of Doppler frequency values to produce a condensed set of Doppler frequency values. In such examples, transmitting the set of Doppler frequency values may include transmitting the condensed set of Doppler frequency values (e.g., to reduce size of a CSI report). That is, when transmitting the set of Doppler frequency values, the UE 106 can be configured to apply the set of commonality parameters to produce a condensed set of Doppler frequency values.

In some examples, the UE 106 can be configured to determine whether the set of commonality parameters corresponds to: (i) a delay-commonality parameter, (ii) a beam-commonality parameter, and/or (iii) a layer-commonality parameter.

In some examples, the commonality parameter(s) may include a delay-commonality parameter. In instances where the Doppler frequency commonality parameters includes a delay-commonality parameter, the UE 106 can be configured to determine, for a set of delay values, a common set of Doppler frequency values (e.g., as the condensed set of Doppler frequency values). In such examples, a set of one or more delay values may correspond to a first beam of a first transmission layer. In such instances, when the UE 106 applies the set of commonality parameters to the set of Doppler frequency values, the UE 106 may transmit the set of Doppler frequency values, in such a way that the delay values associated with the first beam (e.g., of one transmission layer) share common Doppler frequency values (e.g., have the same frequency values for each delay value of the first beam). In such instances, the Doppler frequency values may take on the following condensed form:

$${f}_{l , b , 1 , n}^{( Doppler )} = {f}_{l , b , 2 , n}^{( Doppler )} = … = {f}_{l , b , D , n}^{( Doppler )} for any n ,$$

where n represents time, l represents transmission layer, D represents a delay value, and b represents a beam.

In another example, the commonality parameter(s) may include a beam-commonality parameter. In such examples, a beam corresponds to a transmission layer. In such examples, the UE 106 may apply the beam-commonality parameter to the set of Doppler frequency values. In an example, the UE 106 may determine a common set of Doppler frequency values for the beam as the condensed set of Doppler frequency values. Here, the beams associated with one layer share Doppler frequency values. In such instances, the Doppler frequency values may take on the following condensed form:

$${f}_{l , 1 , d , n}^{( Doppler )} = {f}_{l , 2 , d , n}^{( Doppler )} = … = {f}_{l , B , d , n}^{( Doppler )} for any d , n ,$$

where n represents time e.g., measure in symbols received, or a duration of time, etc.), l represents transmission layer, d represents delay values, and B represents a beam.

In another example, the commonality parameter(s) may include a layer-commonality parameter. In such examples, the set of Doppler frequency values correspond to a plurality of transmission layers. In such instances, to apply the set of commonality parameters to the set of Doppler frequency values, the UE 106 may determine a common set of Doppler frequency values for the plurality of transmission layers. In this way, the UE 106 may yield a condensed set of Doppler frequency values, where multiple transmission layers share the common set of Doppler frequency values. In such instances, the UE 106 may reduce the set of Doppler frequency values to include layer commonality as follows:

$${f}_{1 , b , d , n}^{( Doppler )} = {f}_{2 , b , d , n}^{( Doppler )} = … = {f}_{L , b , d , n}^{( Doppler )} for any b , d , n .$$

where n represents time, d represents delay values, b represents beams, and L represents a transmission layer.

Accordingly, the BS 108 may receive, from the UE 106 and in accordance with the set of commonality parameters, the set of Doppler frequency values as a condensed set of Doppler frequency values. The reported bits that result from applying the layer-commonality parameter is less than if applying the beam-commonality parameter. And the reported bits that result from applying the delay-commonality parameter is less relative to the beam-commonality parameter.

When applying layer-commonality parameter as opposed to the beam-commonality parameter, In some examples, the efficiency of the channel state information (CSI) tends to decrease when applying the layer-commonality parameter relative to the beam-commonality parameter, and likewise when applying the beam-commonality parameter relative to the delay-commonality parameter.

### Scheduling Entity

FIG. 17 is a block diagram illustrating an example of a hardware implementation for a scheduling entity 1700 employing a processing system 1704. In an example, the scheduling entity 1700 may be abase station (BS, such as a gNB) as illustrated in any one or more of FIGS. 1, 2, and/or 3. In another example, the scheduling entity 1700 may be a user equipment (UE) as illustrated in any one or more of FIGS. 1, 2, and/or 3.

The scheduling entity 1700 may include a processing system 1704 having one or more processors 1704. Examples of processors 1704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 1700 may be configured to perform any one or more of the functions described herein. For example, the processor 1704, as utilized in a scheduling entity 1700, may be configured (e.g., in coordination with the memory 1705) to implement any one or more of the processes and procedures described above and illustrated in FIGS. 9-16.

The processing system 1704 may be implemented with a bus architecture, represented generally by the bus 1702. The bus 1702 may include any number of interconnecting buses and bridges depending on the specific application of the processing system 1704 and the overall design constraints. The bus 1702 communicatively couples together various circuits including one or more processors (represented generally by the processor 1704), a memory 1705, and computer-readable media (represented generally by the computer-readable medium 1706). The bus 1702 may also link various other circuits such as timing sources, peripherals, voltage regulators, and power management circuits, which are well known in the art, and therefore, will not be described any further. A bus interface 1708 provides an interface between the bus 1702 and a transceiver 1710. The transceiver 1710 provides a communication interface or means for communicating with various other apparatus over a transmission medium. Depending upon the nature of the apparatus, a user interface 1712 (e.g., keypad, display, speaker, microphone, joystick) may also be provided. Of course, such a user interface 1712 is optional, and some examples, such as a base station, may omit it.

In some aspects of the disclosure, the processor 1704 may include channel state information (CSI) report configuration message circuitry 1740 configured (e.g., in coordination with the memory 1705) for various functions, including, e.g., transmitting a CSI report configuration message to a scheduled entity 106 (e.g., a UE 106). For example, the CSI report configuration message circuitry 1740 may be configured to implement one or more of the functions described above in relation to FIG. 9, including, e.g., block 902.

In some aspects of the disclosure, the processor 1704 may include precoding matrix determining circuitry 1742 configured (e.g., in coordination with the memory 1705) for various functions, including, e.g., determining a downlink (DL) precoding matrix to utilize for precoding a wireless communication. For example, the precoding matrix determining circuitry 1742 may be configured to implement one or more of the functions described above in relation to FIG. 9, including, e.g., blocks 914, 922, and/or 924.

The processor 1704 is responsible for managing the bus 1702 and general processing, including the execution of software stored on the computer-readable medium 1706. The software, when executed by the processor 1704, causes the processing system 1704 to perform the various functions described above for any particular apparatus. The processor 1704 may also use the computer-readable medium 1706 and the memory 1705 for storing data that the processor 1704 manipulates when executing software.

One or more processors 1704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1706. The computer-readable medium 1706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1706 may reside in the processing system 1704, external to the processing system 1704, or distributed across multiple entities including the processing system 1704. The computer-readable medium 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 1706 may store computer-executable code that includes channel state reporting configuration instructions 1750 that configure a scheduling entity 1700 for various functions, including, e.g., transmitting a channel state information (CSI) report configuration message. For example, the CSI report configuration message instructions 1750 may be configured to cause a scheduling entity 1700 to implement one or more of the functions described above in relation to FIG. 9, including, e.g., block 902.

In one or more examples, the computer-readable storage medium 1706 may store computer-executable code that includes precoding matrix determining instructions 1752 that configure a scheduling entity 1700 for various functions, including, e.g., receiving a set of Doppler frequency values and a corresponding set of weight values, determining a precoding matrix, etc. For example, the precoding matrix determining instructions 1752 may be configured to cause a scheduling entity 1700 to implement one or more of the functions described above in relation to FIG. 9, including, e.g., blocks 920, 922, 924, and/or 928.

In one configuration, the apparatus 1700 for wireless communication includes means for transmitting a channel state information (CSI) report configuration message (e.g., via CSI report configuration message circuitry 1740, via transceiver 1710, etc.). The apparatus 1700 includes means for receiving (i) a set of Doppler frequency values, and (ii) a set of weight values that correspond to the set of Doppler frequency values. The apparatus further includes means for transmitting a downlink (DL) signal precoded based at least in part on: (i) the set of Doppler frequency values, and (ii) the set of weight values corresponding to the set of Doppler frequency values. In such examples, the means for transmitting the precoded DL signal includes means for precoding the DL signal based at least in part on the set of Doppler frequency values, and the corresponding set of weight values. In one aspect, the aforementioned means may be the processor(s) 1704, including the precoding matrix determining circuitry 1742 shown in FIG. 17 configured to perform the functions recited by the aforementioned means. In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable storage medium 1706, or any other suitable apparatus or means described in any one of the FIGS. 1, 2, and/or 3, and utilizing, for example, the processes and/or algorithms described herein in relation to FIGS. 9-16.

### Scheduled Entity UE

FIG. 18 is a conceptual diagram illustrating an example of a hardware implementation for an exemplary scheduled entity 1800 employing a processing system 814. In accordance with various aspects of the disclosure, a processing system 1814 may include an element, or any portion of an element, or any combination of elements having one or more processors 1804. For example, the scheduled entity 1800 may be a user equipment (UE) as illustrated in any one or more of FIGS. 1, 2, and/or 3.

The processing system 814 may be substantially the same as the processing system 1704 illustrated in FIG. 17, including a bus interface 1808, a bus 1802, memory 1805, a processor 1804, and a computer-readable storage medium 1806. Furthermore, the scheduled entity 1800 may include a user interface 1812 and a transceiver 1810 substantially similar to those described above in FIG. 17. That is, the processor 1804, as utilized in a scheduled entity 1800, may be configured (e.g., in coordination with the memory 1805) to implement any one or more of the processes described above and illustrated in FIG. 9.

In some aspects of the disclosure, the processor 1804 may include Doppler frequency value determining circuitry 1840 configured (e.g., in coordination with the memory 1805) for various functions, including, for example, transmitting a set of Doppler frequency values. For example, the Doppler frequency value determining circuitry 1840 may be configured to implement one or more of the functions described above in relation to FIG. 9, including, e.g., block 918.

And further, the computer-readable storage medium 1806 may store computer-executable code that includes weight value determining instructions 1852 that configure a scheduled entity 1800 for various functions, including, for example, transmitting a set of weight values corresponding to the set of Doppler frequency values. In an example, the weight value determining instructions 1852 may be configured to cause a scheduled entity 1800 to implement one or more of the functions described above in relation to FIG. 9, including, e.g., block 918.

A method of wireless communication by a user equipment (UE), the method comprising: receiving a set of reference signals; and transmitting, based at least in part on the set of reference signals: a set of Doppler frequency values, and a set of weight values that correspond to the set of Doppler frequency values.

In one configuration, the apparatus 1800 for wireless communication includes means for receiving a set of reference signals and means for transmitting, based at least in part on the set of reference signals: a set of Doppler frequency values, and a set of weight values that correspond to the set of Doppler frequency values. In one aspect, the aforementioned means may be the Doppler frequency value determining circuitry 1840, the weight value determining circuitry 1842, the channel state reporting circuitry 1844 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1, 2, and/or 3, and utilizing, for example, the processes and/or algorithms described herein in relation to FIGS. 9-16.

### Further Examples Having a Variety of Features:

Example 1: A method, apparatus, and non-transitory computer-readable medium for wireless communication by a user equipment (UE), the method including receiving a set of reference signals; and transmitting, based at least in part on the set of reference signals: a set of Doppler frequency values, and a set of weight values that correspond to the set of Doppler frequency values.

Example 2: A method, apparatus, and non-transitory computer-readable medium of Example 1, wherein the set of reference signals corresponds to a first beam of a plurality of beams; and wherein the plurality of beams corresponds to a first transmission layer of a plurality of transmission layers.

Example 3: A method, apparatus, and non-transitory computer-readable medium of Example 2, further including transmitting, based at least in part on the set of reference signals, a set of delay values that corresponds to the first beam.

Example 4: A method, apparatus, and non-transitory computer-readable medium of Example 3, further including wherein each Doppler frequency value of the set of Doppler frequency values is associated with at least one delay value of the set of delay values.

Example 5: A method, apparatus, and non-transitory computer-readable medium of Example 3, wherein each delay value of the set of delay values is associated with at least one Doppler frequency value of the set of Doppler frequency values.

Example 6: A method, apparatus, and non-transitory computer-readable medium of any of Examples 1 to 5, wherein the transmitting of the set of Doppler frequency values includes: applying a size delimiting parameter defining: a first threshold number of Doppler frequency values; or a second threshold number of delay-Doppler value pairs.

Example 7: A method, apparatus, and non-transitory computer-readable medium of any of Examples 1 to 6, further including: quantizing the set of Doppler frequency values to produce a quantized set of Doppler frequency values, wherein the transmitting of the set of Doppler frequency values includes: transmitting the quantized set of Doppler frequency values.

Example 8: A method, apparatus, and non-transitory computer-readable medium of any of Examples 1 to 6, further including: quantizing the set of weight values to produce a quantized set of weight values, wherein the transmitting of the set of weight values includes: transmitting the quantized set of weight values.

Example 9: A method, apparatus, and non-transitory computer-readable medium of any of Examples 1 to 8, further including: determining a set of commonality parameters; and applying the set of commonality parameters to the set of Doppler frequency values to produce a condensed set of Doppler frequency values for transmitting the set of Doppler frequency values.

Example 10: A method, apparatus, and non-transitory computer-readable medium of Example 9, wherein the determining of the set of commonality parameters includes: determining the set of commonality parameters includes one or more of: (i) a delay-commonality parameter, wherein the set of delay values corresponds to a beam of a transmission layer, and wherein applying the set of commonality parameters to the set of Doppler frequency values includes: determining a common set of Doppler frequency values for the set of delay values as the condensed set of Doppler frequency values, (ii) a beam-commonality parameter, wherein a beam corresponds to a transmission layer, and wherein applying the set of beam commonality parameter to the set of Doppler frequency values includes: determining a common set of Doppler frequency values for the beam as the condensed set of Doppler frequency values, or (iii) a layer-commonality parameter, wherein the Doppler frequency values correspond to a plurality of transmission layers, and wherein applying the set of commonality parameters to the set of Doppler frequency values includes: determining a common set of Doppler frequency values for the plurality of transmission layers as the condensed set of Doppler frequency values.

Example 11: A method, apparatus, and non-transitory computer-readable medium of any of Examples 1 to 10, further including: determining a report period defining: a threshold number of reference signals for the set of reference signals (RSs) (e.g., a first set of RSs for a first report period, etc.), or a length of time for the receiving of the set of reference signals, wherein the transmitting of the set of Doppler frequency values and the set of weight values includes: transmitting, according to the report period, the set of Doppler frequency values and the set of weight values.

Example 12: A method, apparatus, and non-transitory computer-readable medium of Example 11, wherein the determining of the set of Doppler frequency values and the set of weight values includes: applying an algorithm minimizing a difference between time instance variations in the Doppler frequency determined over the report period to produce the set of Doppler frequency values and the set of weight values.

Example 13: A method, apparatus, and non-transitory computer-readable medium for wireless communication by a scheduling entity, including: receiving a set of Doppler frequency values; receiving a set of weight values corresponding to the set of Doppler frequency values; and transmitting, via the communication network, a downlink (DL) signal precoded based at least in part on: (i) the set of Doppler frequency values, and (ii) the set of weight values corresponding to the set of Doppler frequency values.

Example 14: A method, apparatus, and non-transitory computer-readable medium of Example 13, wherein the transmitting of the DL signal includes: determining a DL precoding matrix based at least in part on the set of Doppler frequency values and the set of weight values; and transmitting, based at least in part on the DL precoding matrix, the DL signal.

Example 15: A method, apparatus, and non-transitory computer-readable medium of any of Examples 13 to 14, wherein the set of reference signals corresponds to a first beam of a plurality of beams; and wherein the plurality of beams corresponds to a first transmission layer of a plurality of transmission layers.

Example 16: A method, apparatus, and non-transitory computer-readable medium of Example 15, further including: receiving, based at least in part on the set of reference signals, a set of delay values that corresponds to the first beam.

Example 17: A method, apparatus, and non-transitory computer-readable medium of any of Examples 13 to 16, wherein each Doppler frequency value of the set of Doppler frequency values is associated with at least one delay value of the set of delay values.

Example 18: A method, apparatus, and non-transitory computer-readable medium of any of Examples 13 to 17, wherein each delay value of the set of delay values is associated with at least one Doppler frequency value of the set of Doppler frequency values.

Example 19: A method, apparatus, and non-transitory computer-readable medium of any of Examples 13 to 18, further including: determining a report period defining: a threshold number of reference signals for the set of reference signals (RSs) (e.g., a first set of RSs for a first report period, etc.), or a length of time for the receiving of the set of reference signals, wherein the receiving of the set of Doppler frequency values and the set of weight values includes: receiving, according to the report period, the set of Doppler frequency values and the set of weight values.

Example 20: A method, apparatus, and non-transitory computer-readable medium of any of Examples 13 to 17, further including: transmitting a channel state information (CSI) report configuration message, the CSI report configuration message including a timing parameter for the transmitting of the set of Doppler frequency values, the set of weight values, or both the set of Doppler frequency values and the set of weight values.

Example 21: A method, apparatus, and non-transitory computer-readable medium of Example 20, further including: transmitting, in accordance with the CSI report configuration message, a second set of reference signals subsequent to the transmitting of the set of Doppler frequency values, wherein the second set of reference signals include a precoded set of reference signals, wherein the precoded set of reference signals are precoded based at least in part on the set of Doppler frequency values and the set of weight values.

Example 22: A method, apparatus, and non-transitory computer-readable medium of any of Examples 20 to 21, wherein the CSI report configuration message includes a set of channel state information (CSI) report parameters, including the timing parameter, and wherein the receiving of the set of Doppler frequency values and the set of weight values includes: receiving, according to the timing parameter, a CSI report, wherein the CSI report includes at least one of: (i) the set of Doppler frequency values, and (ii) the set of weight values.

Example 23: A method, apparatus, and non-transitory computer-readable medium of any of Examples 13 to 22, wherein the CSI report configuration message includes a size delimiting parameter defining: a first threshold number of Doppler frequency values; or a second threshold number of delay-Doppler value pairs.

Example 24: A method, apparatus, and non-transitory computer-readable medium of any of Examples 13 to 23, further including: transmitting a set of commonality parameters; and wherein the receiving of the set of Doppler frequency values includes: receiving, in accordance with the set of commonality parameters, a condensed set of Doppler frequency values.

This disclosure presents several aspects of a wireless communication network with reference to an exemplary implementation. The actual telecommunication standard, network architecture, and/or communication standard employed will depend on the specific application and the overall design constraints imposed on the system. NR is an emerging wireless communications technology under development. As those skilled in the art will readily appreciate, various aspects described throughout this disclosure may be extended to other telecommunication systems, network architectures and communication standards.

By way of example, the various aspects of this disclosure may be implemented within systems defined by, and/or described in documents from, an organization named “3rd Generation Partnership Project” (3GPP), such as Long-Term Evolution (LTE), as well as others including the Evolved Packet System (EPS), and/or the Universal Mobile Telecommunication System (UMTS), and/or the Global System for Mobile (GSM). Various aspects may also be extended to systems defined by, and/or described in documents from, an organization named the 3rd Generation Partnership Project 2 (3GPP2), such as CDMA1700 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. It should be noted that the terms “network” and “system” are often used interchangeably.

In some examples, a CDMA network may implement a radio technology such as Universal Terrestrial Radio Access (UTRA), which includes Wideband CDMA (WCDMA) as well as other variants. A TDMA network may implement a radio technology such as Global System for Mobile Communications (GSM). An OFDMA network may implement a radio technology such as NR (e.g., 5G NR), Evolved UTRA (E-UTRA), Ultra Mobile Broadband (UMB), IEEE 802.11 (WiFi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use EUTRA. UTRA, E-UTRA, UMTS, LTE, LTE-A, UMB, and GSM are described in 3GPP documents.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

The present disclosure uses the term “coupled” and/or “communicatively coupled” to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-18 may be configured to perform one or more of the methods, features, or steps described herein. The novel algorithms described herein may also be efficiently implemented in software and/or embedded in hardware.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b (a-b); a and c (a-c); b and c (b-c); and a, b and c (a-b-c), as well as any combination with multiples of the same element (e.g., a-a, a-a-a, a-a-b, a-a-c, a-b-b, acc, b-b, b-b-b, b-b-c, c-c, and c-c-c or any other ordering of a, b, and c). As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information, such as a reference signal), accessing (e.g., accessing data in a memory) and the like. Also, “determining” may include resolving, selecting, choosing, establishing and the like.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

The various operations of the disclosed technology may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

It is to be understood that the claims are not limited to the precise configuration and components illustrated above. Various modifications, changes and variations may be made in the arrangement, operation and details of the methods and apparatus described herein without departing from the scope of the claims. The description of the disclosed technology is provided to enable those skilled in the art to practice the various aspects described herein. The claims, however, are not intended to be limited to the aspects shown herein, but are to be accorded the full scope consistent with the language of the claims. Various modifications to these aspects will be readily apparent to those skilled in the art, and the generic principles defined herein may be applied to other aspects.

What is claimed is:

1. A method of wireless communication by a user equipment (UE), the method comprising:
receiving a set of reference signals; and
transmitting, based at least in part on the set of reference signals:
a set of Doppler frequency values, and
a set of weight values that correspond to the set of Doppler frequency values.

2. The method of claim 1,
wherein the set of reference signals corresponds to a first beam of a plurality of beams; and
wherein the plurality of beams corresponds to a first transmission layer of a plurality of transmission layers.

3. The method of claim 2, further comprising:
transmitting, based at least in part on the set of reference signals, a set of delay values that corresponds to the first beam.

4. The method of claim 3, wherein each Doppler frequency value of the set of Doppler frequency values is associated with at least one delay value of the set of delay values.

5. The method of claim 3, wherein each delay value of the set of delay values is associated with at least one Doppler frequency value of the set of Doppler frequency values.

6. The method of claim 1, wherein the transmitting of the set of Doppler frequency values comprises:
applying a size delimiting parameter defining:
a first threshold number of Doppler frequency values; or
a second threshold number of delay-Doppler value pairs.

7. The method of claim 1, further comprising:
quantizing the set of Doppler frequency values to produce a quantized set of Doppler frequency values,
wherein the transmitting of the set of Doppler frequency values comprises:
transmitting the quantized set of Doppler frequency values.

8. The method of claim 1, further comprising:
quantizing the set of weight values to produce a quantized set of weight values,
wherein the transmitting of the set of weight values comprises:
transmitting the quantized set of weight values.

9. The method of claim 1, further comprising:
determining a set of commonality parameters; and
applying the set of commonality parameters to the set of Doppler frequency values to produce a condensed set of Doppler frequency values, wherein the transmitting the set of Doppler frequency values comprises transmitting the condensed set of Doppler frequency values.

10. An apparatus for wireless communication by a user equipment (UE), comprising:
a processor;
a transceiver communicatively coupled to the processor; and
a memory communicatively coupled to the processor,
wherein the apparatus is configured to:
receive a set of reference signals; and
transmit, based at least in part on the set of reference signals:
(i) a set of Doppler frequency values, and
(ii) a set of weight values that correspond to the set of Doppler frequency values.

11. The apparatus of claim 10,
wherein the set of reference signals corresponds to a first beam of a plurality of beams; and
wherein the plurality of beams corresponds to a first transmission layer of a plurality of transmission layers.

12. The apparatus of claim 11, wherein the apparatus is further configured to:
transmit, based at least in part on the set of reference signals, a set of delay values that corresponds to the first beam.

13. The apparatus of claim 10 wherein the transmitting of the set of Doppler frequency values comprises:
applying a size delimiting parameter defining:
a first threshold number of Doppler frequency values; or
a second threshold number of delay-Doppler value pairs.

14. The apparatus of claim 10, wherein the apparatus is further configured to:
quantize the set of Doppler frequency values to produce a quantized set of Doppler frequency values,
wherein the transmitting of the set of Doppler frequency values comprises:
transmitting the quantized set of Doppler frequency values.

15. The apparatus of claim 10, wherein the apparatus further configured to:
quantize the set of weight values to produce a quantized set of weight values,
wherein the transmitting of the set of weight values comprises:
transmitting the quantized set of weight values.

16. A method of wireless communication by a scheduling entity, the method comprising:
receiving a set of Doppler frequency values;
receiving a set of weight values corresponding to the set of Doppler frequency values; and
transmitting, via a communication network, a downlink (DL) signal precoded based at least in part on:
(i) the set of Doppler frequency values, and
(ii) the set of weight values corresponding to the set of Doppler frequency values.

17. The method of claim 16, wherein the transmitting of the DL signal comprises:
determining a DL precoding matrix based at least in part on the set of Doppler frequency values and the set of weight values; and
transmitting, based at least in part on the DL precoding matrix, the DL signal.

18. The method of claim 16, further comprising:
transmitting, to a user equipment, a set of reference signals, wherein the set of reference signals corresponds to a first beam of a plurality of beams; and
wherein the plurality of beams corresponds to a first transmission layer of a plurality of transmission layers.

19. The method of claim 18, further comprising:
receiving, based at least in part on the set of reference signals, a set of delay values that corresponds to the first beam.

20. The method of claim 19, wherein each Doppler frequency value of the set of Doppler frequency values is associated with at least one delay value of the set of delay values.

21. The method of claim 19, wherein each delay value of the set of delay values is associated with at least one Doppler frequency value of the set of Doppler frequency values.

22. The method of claim 18, further comprising:
determining a report period defining: a threshold number of reference signals for the set of reference signals, or a length of time for the receiving of the set of reference signals,
wherein the receiving of the set of Doppler frequency values and the set of weight values comprises:
receiving, according to the report period, the set of Doppler frequency values and the set of weight values.

23. The method of claim 16, further comprising:
transmitting a channel state information (CSI) report configuration message, the CSI report configuration message comprising a timing parameter for the transmitting of the set of Doppler frequency values, the set of weight values, or both the set of Doppler frequency values and the set of weight values.

24. The method of claim 16, wherein the CSI report configuration message comprises a size delimiting parameter defining:
a first threshold number of Doppler frequency values; or
a second threshold number of delay-Doppler value pairs.

25. The method of claim 16, further comprising:
transmitting a set of commonality parameters; and
wherein the receiving of the set of Doppler frequency values comprises:
receiving, in accordance with the set of commonality parameters, a condensed set of Doppler frequency values.

26. An apparatus for wireless communication by a scheduling entity, comprising:
a processor;
a transceiver communicatively coupled to the processor; and
a memory communicatively coupled to the processor,
wherein the apparatus is configured to:
receive a set of Doppler frequency values;
receive a set of weight values; and
transmit, via the transceiver, a downlink (DL) signal precoded based at least in part on:
(i) the set of Doppler frequency values, and
(ii) the set of weight values corresponding to the set of Doppler frequency values.

27. The apparatus of claim 26, wherein the transmitting of the DL signal comprises:
determining a DL precoding matrix based at least in part on the set of Doppler frequency values and the set of weight values; and
transmitting, based at least in part on the DL precoding matrix, the DL signal.

28. The apparatus of claim 26, wherein the apparatus is further configured to:
transmit a set of reference signals, wherein the set of reference signals correspond to the set of Doppler frequency values, and
wherein the set of reference signals corresponds to a first beam of a plurality of beams, and wherein the plurality of beams corresponds to a first transmission layer of a plurality of transmission layers.

29. The apparatus of claim 28, wherein the apparatus is further configured to:
receive, based at least in part on the set of reference signals, a set of delay values that corresponds to the first beam.

30. The apparatus of claim 26, wherein the apparatus is further configured to:
determine an allocation of communication resources for receiving a set of reference signals,
wherein the receiving of the set of Doppler frequency values and the set of weight values comprises:
receiving, via the allocation of communication resources, the set of Doppler frequency values and the set of weight values.
